(19) United States
(12) Patent Application Publication
(10) Pub. No.: US 2014/0340586 A1
(43) Pub. Date: Nov. 20, 2014

(54) ILLUMINATION DEVICE, DISPLAY DEVICE, AND TELEVISION RECEIVING DEVICE

(71) Applicant: Kentaro Terashima, Osaka (JP)

(72) Inventor: Kentaro Terashima, Osaka (JP)

(73) Assignee: SHARP KABUSHIKI KAISHA, Osaka (JP)

(21) Appl. No.: 14/344,143

(22) PCT Filed: Sep. 7, 2012
(86) PCT No.: PCT/JP2012/072914

§ 371 Date: Mar. 11, 2014

(30) Foreign Application Priority Data
Sep. 14, 2011 (JP) 2011-200694

(51) Int. Cl. F21V 8/00

(52) U.S. Cl. CPC G02B 6/0031; G02B 6/0068; G02B 6/0088
USPC 348/790; 362/609; 349/65

(57) ABSTRACT

This backlight device (illumination device) (12) is provided with: a plurality of LEDs (light sources) (17) arranged in a row at intervals; a light-guide plate (16) having a light-receiving surface (16b) that is arranged opposing the LEDs (17) and that receives light from the LEDs (17) and a light-emitting surface (16a) from which the light that entered is emitted; a reflective sheet (reflective member) (20) arranged so as to cover the surface of the light-guide plate (16) opposite to the light-emitting surface (16a) and that reflects light toward the light-emitting surface (16a); and an extended reflective part (26) provided in an edge portion of the reflective sheet (20), the extended reflective part (26) extending toward the LEDs (17) from the light-receiving surface (16b), the extended reflective part (26) having openings (27) formed therein that correspond to the arrangement pattern of the LEDs (17), thereby being arranged corresponding to the non-arrangement pattern where the LEDs (17) are not provided.

### TECHNICAL FIELD

The present invention relates to an illumination device, a display device, and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. In the liquid crystal display device, a liquid crystal panel used therein does not emit light, and therefore, it is necessary to separately provide a backlight device as an illumination device. The backlight devices are largely categorized into a direct-lighting type and an edge-lighting type depending on the mechanism thereof. In order to make the liquid crystal display device even thinner, it is preferable to use an edge-lighting type backlight device, and a known example thereof is disclosed in Patent Document 1 below.

### RELATED ART DOCUMENT

### Patent Document

Patent Document 1: Japanese Patent Application Laid-Open Publication No. 2007-265882

### Problems to be Solved by the Invention

In some of the edge-lighting type backlight devices, a plurality of light sources are arranged at intervals along a light-receiving surface disposed at an edge of the light guide plate, but in such a configuration, the following problem sometimes occurs. That is, there is a possibility that the amount of light emitted from the plurality of light sources and entering the light-receiving surface becomes uneven due to the arrangement pattern and non-arrangement pattern of the plurality of light sources that are arranged at intervals. In particular, the unevenness becomes more pronounced when the distance between the light sources and the light-receiving surface is made smaller in order to make the frame in the liquid crystal display device and the backlight device narrower.

On the other hand, in some of the backlight devices, an edge of the reflective sheet disposed on the rear side of the light guide plate is extended toward the light sources in order to improve the light utilization efficiency, but if the reflective sheet has warping, the edge of the extended part is deformed and enters a space between the light sources and the light guide plate. In this case, light from the light sources is blocked by the deformed edge of the extended part of the reflective sheet, and the amount of light that enters the light guide plate is reduced, which possibly lowers the brightness.

### SUMMARY OF THE INVENTION

The present invention was completed in view of the above-mentioned situation, and an object thereof is to mitigate uneven brightness and brightness reduction.

### Means for Solving the Problems

An illumination device of the present invention includes: a plurality of light sources arranged at intervals; a light guide plate having a light-receiving surface facing the light sources to receive light from the light sources, and a light-emitting surface through which light that entered the light guide plate is emitted; a reflective member disposed to cover a surface of the light guide plate opposite to the light-emitting surface, the reflective member reflecting light toward the light-emitting surface; and an extended reflective part constituted of an edge of the reflective member, the extended reflective part extending from the light-receiving surface toward the light sources, the extended reflective part having a shape consistent with a non-arrangement pattern of the light sources by having openings formed therein that correspond to an arrangement pattern of the light sources.

With this configuration, light emitted from the plurality of light sources is reflected by the reflective member toward the light-emitting surface in the process of travelling through the light guide plate after entering the light-receiving surface of the light guide plate that is disposed to face the light sources, and is thereby emitted from the light-emitting surface efficiently. An edge of the reflective member is an extended reflective part that extends from the light-receiving surface to the light sources, and the extended reflective part having a shape that corresponds to the non-arrangement pattern of the light sources by having openings formed therein that correspond to the arrangement pattern of the light sources. Therefore, when the light from the light sources travels toward the light-receiving surface, the openings that correspond to the arrangement pattern of the light sources can mitigate reflection of light where light reflection tends to be excessive, and the extended reflective part that has a shape corresponding to the non-arrangement pattern of the light sources can improve reflection of light where light reflection tends to be insufficient. Thus, the amount of light that enters the light-receiving surface of the light guide plate evens out regardless of the arrangement pattern and the non-arrangement pattern of the plurality of light sources arranged at intervals. As a result, uneven brightness of light that is emitted from the light-emitting surface of the light guide plate is less likely to occur. In particular, when the distance between the light sources and the light-receiving surface of the light guide plate is made smaller, the uneven brightness is more likely to occur, and therefore, this configuration is useful in achieving a narrower frame in the illumination device.

In addition, even when the extended reflective part is deformed due to warping and the like, because the extended reflective part has openings formed therein that correspond to the arrangement pattern of the light sources, the deformed extended reflective part is less likely to enter a space between the light sources and the light-receiving surface, and even if the extended reflective part enters the space, a portion thereof entering the space will be small. This makes it difficult for the deformed extended reflective part to block light from the light sources, and this configuration is preferable in preventing the brightness reduction.

As embodiments of the present invention, the following configurations are preferred.

(1) The illumination device further includes: a light source substrate on which the plurality of light sources are mounted; and a chassis having a bottom plate that is disposed on the reflective member on a side opposite to the light guide plate, the chassis housing the light source substrate, the light guide plate, and the reflective member, and the extended reflective part extends to a position where the extended reflective part is sandwiched between the light source substrate and the bottom plate of the chassis. With this configuration, by sandwiching the extended reflective part between the light source substrate and the bottom plate of the chassis, even if the extended reflective part has warping, the warping can be removed, which prevents deformation of the extended reflective part. This makes it even more difficult for the extended reflective part to enter a space between the light sources and the light-receiving surface, and this configuration is more preferable in achieving the brightness reduction.

(2) The extended reflective part is formed such that an extended edge face has recesses and protrusions that repeat periodically in a direction along which the light sources are aligned, and a plurality of the openings are arranged at intervals along the direction along which the light sources are aligned. In this configuration, the edge of the extended reflective part is not disposed where the light sources are arranged, as opposed to a configuration in which the extended edge face of the extended reflective part having openings is a straight line and portions of the edge of the extended reflective part are disposed where the light sources are arranged, and therefore, the light reflection at locations where the light sources are arranged can be more effectively mitigated.

(3) The openings are formed in an entire area that overlaps the light sources in a plan view. In this configuration, because the openings are formed in the entire area where most of the light emitted from the light sources is radiated, it is possible to effectively mitigate the light reflection that tends to be excessive at locations where the light sources are arranged, and thus, this configuration is more preferable in mitigating uneven brightness.

(4) The openings each have a symmetric shape with respect to the direction along which the light sources are aligned, and the light sources are each positioned so as to share the same center as one of the openings with respect to the direction along which the light sources are aligned. With this configuration, the openings each have a symmetric shape with respect to the direction along which the light sources are aligned, and the light sources are each positioned so as to share the same center as one of the openings with respect to the direction along which the light sources are aligned. Therefore, the amount of light reflected by the extended reflective part having the openings formed therein is not likely to be uneven with respect to the direction along which the light sources are aligned, which makes this configuration more preferable in mitigating the uneven brightness.

(5) The openings have a shape that corresponds to an outer shape of the light sources. With this configuration, an even positional relationship is maintained between the edges of the openings in the extended reflective part and the light sources with respect to the circumference direction of each light source, and therefore, the amount of light reflected by the extended reflective part is not likely to be uneven with respect to the circumference direction of each light source. This makes this configuration more preferable in mitigating the uneven brightness.

(6) The extended reflective part is formed such that an area of each of the openings becomes gradually smaller in a direction from the light sources toward the light guide plate, causing an area of the extended reflective part to be gradually larger in the direction from the light sources toward the light guide plate. Light emitted from the light sources spreads and evens out in a direction further away from the light sources, and therefore, in this configuration, in locations closer to the light sources, by having the light pass through the openings, the reflection of light is mitigated, which effectively mitigates the unevenness. On the other hand, in locations further away from the light sources, the light is reflected more efficiently by the extended reflective part, which increases the brightness. As a result, the uneven brightness can be mitigated even more effectively.

(7) The extended reflective part is formed such that an extended edge face thereof has a sinusoidal shape. With this configuration, it is possible to prevent the extended reflective part from being bent or warped when the reflective member is manufactured, and because stress is less likely to be concentrated at the extended reflective part, the extended reflective part is less susceptible to tear or break.

(8) The openings each have a tapered shape such that an opening area thereof becomes gradually smaller in a direction from the light sources toward the light guide plate. By making the edge of the opening tapered as described above, the area of the opening gradually decreases in the direction from the light sources toward the light guide plate, while the area of the extended reflective part gradually increases in the direction from the light sources toward the light guide plate. This makes it possible to mitigate the uneven brightness more effectively.

(9) The light sources are light-emitting diodes. With this configuration, it is possible to achieve higher brightness, lower energy consumption, and the like.

Next, in order to achieve the above-mentioned object, a display device of the present invention includes the above-mentioned illumination device and a display panel that performs display using light from the illumination device.

With such a display device, the illumination device that supplies light to the display panel is not likely to cause uneven or lower brightness, and therefore, it is possible to realize display with excellent display quality.

Examples of the display panel include a liquid crystal panel. As a liquid crystal display device, such a display device can be applied to various applications such as a television or the display of a personal computer, for example, and is particularly suitable for large screens.

### Effects of the Invention

According to the present invention, it is possible to mitigate uneven brightness and brightness reduction.

### BRIEF DESCRIPTION OF THE DRAWINGS

FIG. 1 is an exploded perspective view that shows a schematic configuration of a television receiver and a liquid crystal display device according to Embodiment 1 of the present invention.

FIG. 2 is a rear view of the television receiver and the liquid crystal display device.

FIG. 3 is an exploded perspective view showing a schematic configuration of a liquid crystal display unit that constitutes a part of the liquid crystal display device.

FIG. 4 is a cross-sectional view that shows a cross-sectional configuration of the liquid crystal display device along the shorter side direction.

FIG. 5 is a plan view showing an arrangement configuration of a chassis, light guide plate, and LED unit in a backlight device provided in the liquid crystal display device.

FIG. 6 is an enlarged plan view showing an arrangement configuration of the light guide plate, an extended reflective part of a reflective sheet, and the LED unit.

FIG. 7 is a cross-sectional view along the line vii-vii of FIG. 6 (in a region where a light source is arranged).

FIG. 8 is a cross-sectional view along the line viii-viii of FIG. 6 (in a region where a light source is not arranged).

FIG. 9 is a cross-sectional view along the line vii-vii of FIG. 6, showing a work procedure to assemble respective constituting members of the liquid crystal display unit that constitutes a part of the liquid crystal display device.

FIG. 10 is an enlarged plan view showing an arrangement configuration of a light guide plate, an extended reflective part of a reflective sheet, and an LED unit of Embodiment 2 of the present invention.

FIG. 11 is an enlarged plan view showing an arrangement configuration of a light guide plate, an extended reflective part of a reflective sheet, and an LED unit of Embodiment 3 of the present invention.

FIG. 12 is an enlarged plan view showing an arrangement configuration of a light guide plate, an extended reflective part of a reflective sheet, and an LED unit of Embodiment 4 of the present invention.

FIG. 13 is an enlarged plan view showing an arrangement configuration of a light guide plate, an extended reflective part of a reflective sheet, and an LED unit of Embodiment 5 of the present invention.

FIG. 14 is an enlarged plan view showing an arrangement configuration of a light guide plate, an extended reflective part of a reflective sheet, and an LED unit of Embodiment 6 of the present invention.

### DETAILED DESCRIPTION OF EMBODIMENTS

### Embodiment 1

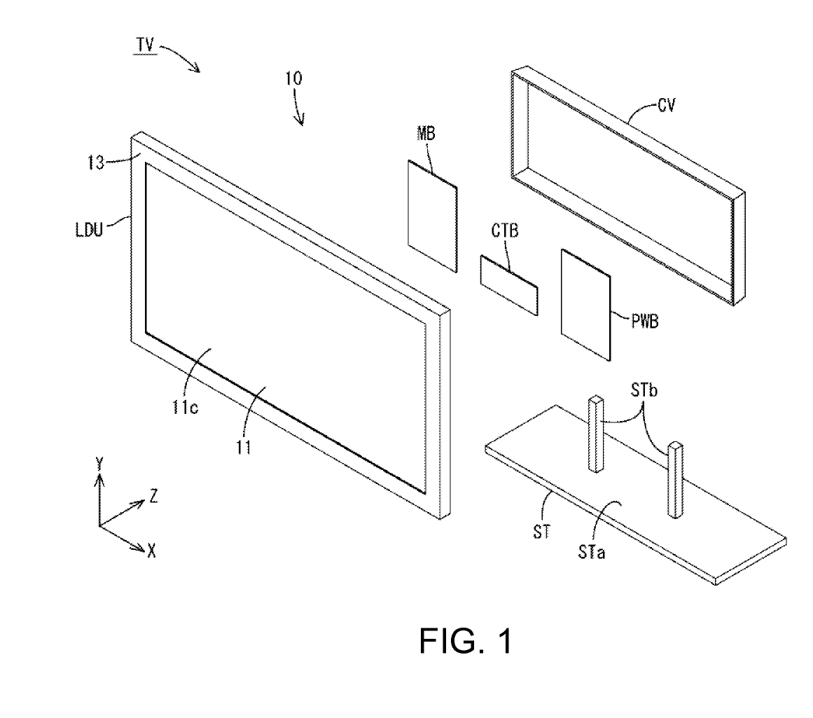

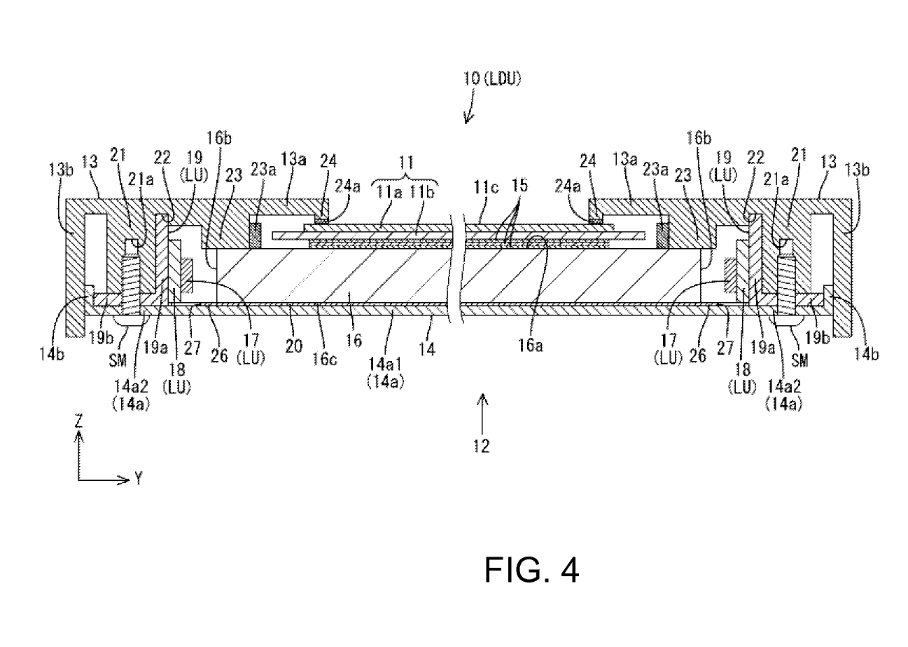

Embodiment 1 of the present invention will be described with reference to FIGS. 1 to 9. In the present embodiment, a liquid crystal display device 10 will be described as an example. The drawings indicate an X axis, a Y axis, and a Z axis in a portion of the drawings, and each of the axes indicates the same direction for the respective drawings. The upper side of FIG. 4 is the front side, and the lower side is the rear side.

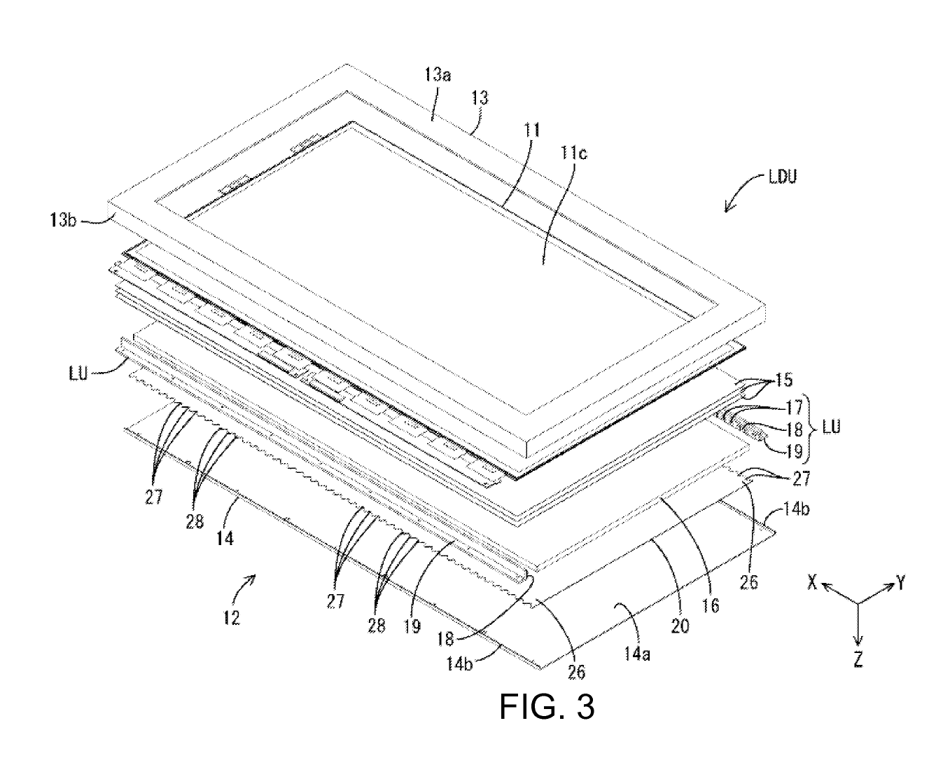

As shown in FIG. 1, a television receiver TV of the present embodiment includes: a liquid crystal display unit (display unit) LDU; various boards PWB, MB, and CTB that are attached to the back side (rear side) of the liquid crystal display unit LDU; a cover member CV attached to the rear side of the liquid crystal display unit LDU so as to cover the various boards PWB, MB, and CTB; and a stand ST. The television receiver TV is supported by the stand ST such that the display surface of the liquid crystal display unit LDU is parallel to the vertical direction (Y axis direction). The liquid crystal display device 10 of the present embodiment is obtained by removing at least the configuration for receiving television signals (such as a tuner part of the main board MB) from the television receiver TV having the above-mentioned configuration. As shown in FIG. 3, the liquid crystal display unit LDU is formed to be a horizontally-long quadrangle (rectangular shape) as a whole, and includes a liquid crystal panel 11 that is a display panel, and a backlight device (illumination device) 12 that is an external light source. The liquid crystal panel 11 and the backlight device 12 are held as one component by a frame (first exterior member) 13 and a chassis (second exterior member) 14 that are exterior members constituting the exterior of the liquid crystal display device 10. The chassis 14 of the present embodiment constitutes a part of the exterior members and also a part of the backlight device 12.

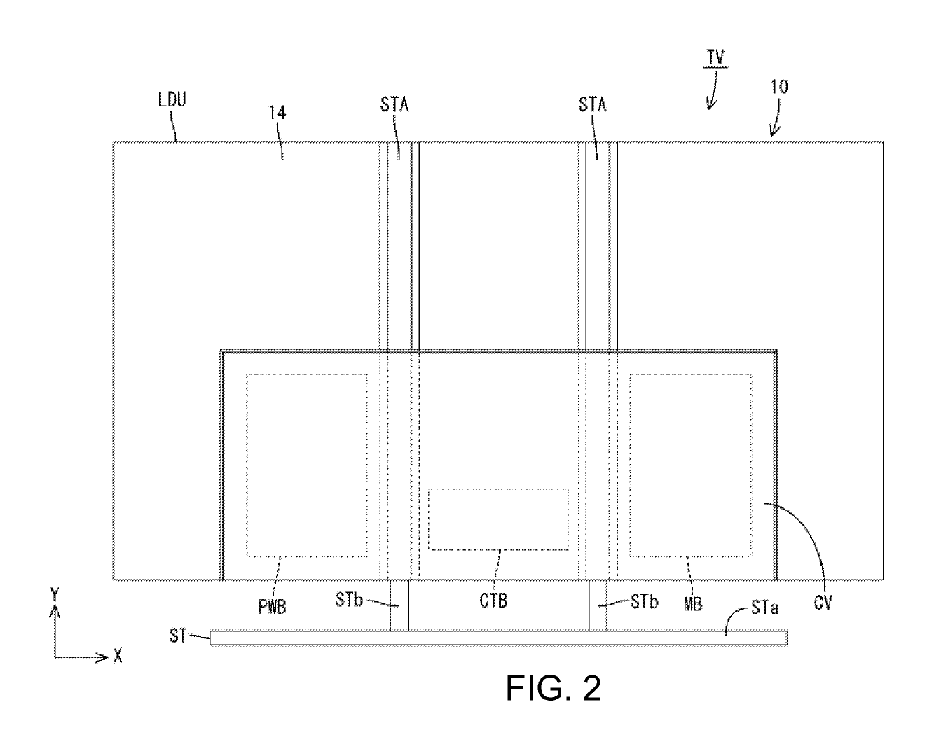

First, the configuration of the rear side of the liquid crystal display device 10 will be explained. As shown in FIG. 2, on the rear side of the chassis 14 that constitutes the rear exterior of the liquid crystal display device 10, a pair of stand attachment members STA extending along the Y axis direction is attached at two locations that are separated from each other along the X axis direction. The cross-sectional shape of these stand attachment members STA is a substantially channel shape that opens toward the chassis 14, and a pair of support columns STb of the stand ST is inserted into spaces formed between the stand attachment members STA and the chassis 14, respectively. Wiring members (such as electric wires) connected to an LED substrate 18 of the backlight device 12 run through a space inside of the stand attachment members STA. The stand ST is constituted of a base STa that is disposed in parallel with the X axis direction and the Z axis direction, and a pair of support columns STb standing on the base STa along the Y axis direction. The cover member CV is made of a synthetic resin, and is attached so as to cover about a half of the lower part of the rear side of the chassis 14 of FIG. 2, while crossing over the pair of stand attachment members STA along the X axis direction. Between the cover member CV and the chassis 14, a component housing space is provided to house the components mentioned below such as various boards PWB, MB, and CTB.

As shown in FIG. 2, the various boards PWB, MB, and CTB include a power supply board PWB, a main board MB, and a control board CTB. The power supply board PWB is a power source for the liquid crystal display device 10, and can supply driving power to other boards MB and CTB, LEDs 17 of the backlight device 12, and the like. Therefore, the power supply board PWB doubles as an LED driver board that drives the LEDs 17. The main board MB at least has a tuner part that can receive television signals, and an image processing part that conducts image-processing on the received television signals (neither the tuner part or the image processing part is shown in the figure), and can output the processed image signals to the control board CTB described below. When the liquid crystal display device 10 is connected to a not-shown external video playback device, an image signal from the video playback device is inputted into the main board MB, and the main board MB can output the image signal to the control board CTB after processing the signal at the image processing part. The control board CTB has the function of converting the image signal inputted from the main board MB to a signal for driving liquid crystal, and supplying the converted signal for liquid crystal to the liquid crystal panel 11.

As shown in FIG. 3, the liquid crystal display unit LDU that constitutes a part of the liquid crystal display device 10 is configured such that the main constituting components thereof are housed in a space between the frame (front frame) 13 that constitutes the front exterior and the chassis (rear chassis) 14 that constitutes the rear exterior. The main constituting components housed between the frame 13 and the chassis 14 at least include the liquid crystal panel 11, optical members 15, a light guide plate 16, and an LED unit (light source unit) LU. Among them, the liquid crystal panel 11, the optical members 15, and the light guide plate 16 are stacked on top of the other, and are held by being sandwiched by the frame 13 disposed on the front side and the chassis 14 disposed on the rear side. The backlight device 12 is constituted of the optical members 15, the light guide plate 16, the LED units LU, and the chassis 14, and is the configuration that is obtained by removing the liquid crystal panel 11 and the frame 13 from the liquid crystal display unit LDU described above. A pair of LED units LU, which is a part of the backlight device 12, is disposed between the frame 13 and the chassis 14 so as to be on the respective sides of the light guide plate 16 in the shorter side direction (Y axis direction). The LED unit LU is constituted of the LEDs 17, which are the light sources, an LED substrate (light source substrate) 18 on which the LEDs 17 are mounted, and a heat dissipating member (heat spreader, light source attachment member) 19 to which the LED substrate 18 is attached. The respective constituting components will be explained below.

As shown in FIG. 3, the liquid crystal panel 11 is formed in a horizontally-long quadrangular shape (rectangular shape) in a plan view, and is configured by bonding a pair of glass substrates having high light transmittance to each other with a prescribed gap therebetween, and by injecting liquid crystal between the two substrates. Of the two substrates 11a and 11b, one on the front side (front surface side) is a CF substrate 11a, and the other on the rear side (rear surface side) is an array substrate 11b. In the array substrate 11b on the rear side, switching elements (TFTs, for example) connected to source wiring lines and gate wiring lines that are intersecting with each other, pixel electrodes connected to the switching elements, an alignment film, and the like are provided. As shown in FIG. 4, the array substrate 11b is formed larger than the CF substrate 11 in a plan view, and is disposed such that edge portions thereof protrude toward the outside beyond the CF substrate 11a. On the other hand, in the CF substrate 11a on the front side, color filters having respective colored portions such as R (red), G (green), and B (blue) arranged in a prescribed pattern, an opposite electrode, an alignment film, and the like are provided. Polarizing plates are respectively provided on outer sides of the two substrates 11a and 11b.

As shown in FIG. 4, the liquid crystal panel 11 is stacked on the front side of the optical members 15 described below, and the rear surface thereof (outer surface of a polarizing plate on the rear side) is in close contact with the optical members 15 with almost no gap. With this configuration, it is possible to prevent dust from entering a space between the liquid crystal panel 11 and the optical members 15. The display surface 11c of the liquid crystal panel 11 is constituted of a display region that is in the center of the surface and that can display images, and a non-display region that is in the outer edges of the surface and that is formed in a frame shape surrounding the display region. The liquid crystal panel 11 is connected to the control board CTB via driver parts for driving liquid crystal, and based on signals inputted from the control board CTB, an image is displayed in the display region on the display surface 11c thereof.

As shown in FIG. 3, the optical members 15 have a horizontally-long quadrangular shape in a plan view as in the liquid crystal panel 11, and the size thereof (shorter side dimension and longer side dimension) is the same as that of the liquid crystal panel 11. The optical members 15 are stacked on the front side (side from which light is emitted) of the light guide plate 16 described below, and are sandwiched between the liquid crystal panel 11 described above and the light guide plate 16. Each of the optical members 15 is a sheet-shaped member, and the optical members 15 are constituted of three sheets stacked together. Specific types of optical members 15 include a diffusion sheet, a lens sheet, a reflective polarizing sheet, and the like, for example, and it is possible to appropriately choose any of these as optical members 15.

The light guide plate 16 is made of a synthetic resin (an acrylic resin such as PMMA or a polycarbonate, for example) with a higher refractive index than air and almost completely transparent (excellent light transmission). As shown in FIGS. 3 to 5, the light guide plate 16 has a horizontally-long quadrangular shape in a plan view, in a similar manner to the liquid crystal panel 11 and the optical members 15, and is in a plate-shape that is thicker than the optical members 15. The longer side direction on the main surface of the light guide plate 16 matches the X axis direction, the shorter side direction matches the Y axis direction, and the thickness direction intersecting the main surface matches the Z axis direction. The light guide plate 16 is placed on the rear side of the optical members 15, and is sandwiched between the optical members 15 and the chassis 14. As shown in FIG. 4, in the light guide plate 16, at least the shorter side dimension thereof is greater than the respective shorter side dimensions of the liquid crystal panel 11 and the optical members 15, and the light guide plate 16 is disposed such that respective edges in the shorter side direction (respective edges along the longer side direction) protrude toward outside beyond respective edges of the liquid crystal panel 11 and the optical members 15 (so as not to overlap in a plan view). The light guide plate 16 has a pair of LED units LU at respective sides thereof in the shorter side direction, thereby being interposed therebetween in the Y axis direction, and light from the LEDs 17 enters the respective shorter side edges of the light guide plate 16. The light guide plate 16 has the function of guiding therethrough the light of LEDs 17 that entered from the respective shorter side edges and emitting the light toward the optical members 15 (front side).

Of the main surfaces of the light guide plate 16, the surface facing the front side (surface facing the optical members 15) is a light-emitting surface 16a that emits light from the interior toward the optical members 15 and the liquid crystal panel 11. Of the outer end faces continued from the main surfaces of the light guide plate 16, two end faces on the longer sides that are longer in the X axis direction (two end faces at the respective edges in the shorter side direction) respectively face the LEDs 17 (LED substrates 18) with a prescribed space therebetween, and these two end faces are a pair of light-receiving surfaces 16b through which light from the LEDs 17 enters. The light-receiving surfaces 16b are each on a plane parallel to that defined by the X axis direction and the Z axis direction (main surface of the LED substrate 18), and are substantially perpendicular to the light-emitting surface 16a. The direction along which the LEDs 17 and the light-receiving surfaces 16b are aligned with respect to each other is the same as the Y axis direction, and is parallel to the light-emitting surface 16a.

As shown in FIG. 4, on the rear side of the light guide plate 16, or in other words, on a surface 16c that is opposite to the light-emitting surface 16a (which is the surface facing the chassis 14), a reflective sheet 20 (reflective member) is disposed so as to cover almost the entire area of the surface 16c. The reflective sheet 20 can reflect light, which exits out from the surface 16c toward the rear side, back to the front side, that is, toward the light-emitting surface 19a. In other words, the reflective sheet 20 is sandwiched between the chassis 14 and the light guide plate 16. The reflective sheet 20 is made of a synthetic resin, and the surface thereof is a highly reflective white. The reflective sheet 20 is in a horizontally-long quadrangle shape in a plan view as in the light guide plate 16, and the shorter side dimension thereof is greater than the shorter side dimension of the light guide plate 16. Respective edges (respective longer side edges) are disposed protruding from the light-receiving surfaces 16b of the light guide plate 16 toward the LEDs 17, and constitute a pair of extended reflective parts 26. The extended reflective parts 26 in the reflective sheet 20 are respectively interposed between the LEDs 17 and the light-receiving surfaces 16b of the light guide plate 16, and are disposed on the rear side of the respective spaces between the LEDs 17 and the light-receiving surfaces 16b. In this way, the extended reflective parts 26 can reflect light that diagonally travels from the LEDs 17 toward the chassis 14, and can cause the reflected light to efficiently enter the light-receiving surfaces 16b. On at least one of the light-emitting surface 16a and the opposite surface 16c of the light guide plate 16, a reflective portion (not shown) that reflects light from the interior or a diffusion portion (not shown) that diffuses light from the interior is patterned so as to have a prescribed in-plane distribution, thereby controlling light emitted from the light-emitting surface 16a to have an even distribution in the plane.

Next, configurations of the LEDs 17, the LED substrate 18, and the heat dissipating member 19 that constitute the LED unit LU will be explained in this order. As shown in FIGS. 3 and 4, the LEDs 17 of the LED unit LU have a configuration in which an LED chip is sealed with a resin on a substrate part that is affixed to the LED substrate 18. The LED chip mounted on the substrate part has one type of primary light-emitting wavelength, and specifically, only emits blue light. On the other hand, the resin that seals the LED chip has a fluorescent material dispersed therein, the fluorescent material emitting light of a prescribed color by being excited by the blue light emitted from the LED chip. This combination of the LED chip and the fluorescent material causes white light to be emitted overall. As the fluorescent material, a yellow fluorescent material that emits yellow light, a green fluorescent material that emits green light, and a red fluorescent material that emits red light, for example, can be appropriately combined, or one of them can be used on its own. Each of the LEDs 17 is of a so-called top-emitting type in which the side opposite to that mounted onto the LED substrate 18 (side facing the light-receiving surface 16b of the light guide plate 16) is the primary light-emitting surface.

As shown in FIGS. 3 to 5, the LED substrates 18 of the LED units LU are each formed in a narrow plate shape that extends along the longer side direction (X axis direction, longitudinal direction of the light-receiving surface 16b) of the light guide plate 16, and are housed between the frame 13 and the chassis 14 such that each main surface thereof is parallel to the X axis direction and the Z axis direction, or in other words, in parallel with the light-receiving surfaces 16b of the light guide plate 16. On the inner main surfaces of the respective LED substrates 18, or in other words, on the surfaces facing the light guide plate 16 (surfaces opposing the light guide plate 16), the LEDs 17 having the above-mentioned configuration are mounted, and these surfaces are mounting surfaces 18a. On the mounting surfaces 18a of the LED substrates 18, a plurality of LEDs 17 are arranged in a row (in a line) along the length direction (X axis direction) at prescribed intervals. That is, the plurality of LEDs 17 are arranged at intervals along the longer side direction on the respective longer edges of the backlight device 12. The intervals between respective adjacent LEDs 17 along the X axis direction are substantially equal to each other, or in other words, the LEDs 17 are arranged at substantially the same pitch. The arrangement direction of the LEDs 17 corresponds to the length direction (X axis direction) of the LED substrates 18. On the mounting surfaces 18a of the LED substrates 18, wiring patterns (not shown) made of a metal film (such as copper foil) are formed. The wiring patterns extend along the X axis direction and cross over the group of LEDs 17 so as to connect the adjacent LEDs 17 to each other in series. By connecting terminals that are formed at respective ends of the wiring patterns to the power supply board PWB via wiring members such as connectors and electric wires, driving power is supplied to the respective LEDs 17. Because the pair of LED substrates 18 is housed between the frame 13 and the chassis 14 such that the respective mounting surfaces 18a for the LEDs 17 face each other, the primary light-emitting surfaces of the respective LEDs 17 that are mounted on the two LED substrates 18 face each other, and the optical axis of each LED 17 substantially coincides with the Y axis direction. The base member of the LED substrate 18 is made of a metal such as aluminum, for example, and the above-described wiring pattern (not shown) is formed on the surface via an insulating layer. The base member of the LED substrate 18 may alternatively be formed of an insulating material such as ceramics.

As shown in FIGS. 3 to 5, the heat dissipating member 19 of the LED unit LU is made of a metal such as aluminum, for example, that has excellent heat conductivity. The heat dissipating member 19 is constituted of an LED attachment section (light source attachment section) 19a to which the LED substrate 18 is attached, and a heat dissipating section 19b that makes surface-to-surface contact with the plate surface of the chassis 14, and these two sections form a bent shape having a substantially L-shaped cross section. The LED attachment section 19a is in a plate shape that is in parallel with the surface of the LED substrate 18 and the light-receiving surface 16b of the light guide plate 16, and the longer side direction corresponds to the X axis direction, the shorter side direction corresponds to the Z axis direction, and the thickness direction corresponds to the Y axis direction, respectively. On the inner surface of the LED attachment section 19a, or in other words, on the surface that faces the light guide plate 16, the LED substrate 18 is attached. While the longer side dimension of the LED attachment section 19a is substantially the same as the longer side dimension of the LED substrate 18, the shorter side dimension of the LED attachment section 19a is slightly greater than the shorter side dimension of the LED substrate 18. Outer surface of the LED attachment section 19a, that is, the surface opposite to the surface on which the LED substrate 18 is attached faces a protruding member 21 of the frame 13, which will be later described. That is, the LED attachment section 19a is interposed between the protruding member 21 of the frame 13 and the light guide plate 16. The LED attachment section 19a makes surface-to-surface contact with the protruding member 21, and in this manner, heat generated from the LEDs 17 due to illumination can be transferred to the frame 13 having the protruding member 21 through the LED substrate 18 and the LED attachment section 19a, and can be dissipated therefrom. The LED attachment section 19a is configured to rise from the inner edge, or in other words, the edge closer to the LEDs 17 (light guide plate 16) of the heat dissipating section 19b described below toward the front side, or toward the frame 13 along the Z axis direction.

As shown in FIGS. 3 to 5, the heat dissipating section 19b is formed in a plate shape that is parallel to the surface of the chassis 14, and the longer side direction corresponds to the X axis direction, the shorter side direction corresponds to the Y axis direction, and the thickness direction corresponds to the Z axis direction, respectively. The rear surface of the heat dissipating section 19b, or in other words, the surface facing the chassis 14 is entirely in contact with the surface of the chassis 14. In this way, heat generated from the LEDs 17 due to illumination can be transferred to the chassis 14 through the LED substrate 18, the LED attachment section 19a, and the heat dissipating section 19b, and can be dissipated therefrom. The longer side dimension of the heat dissipating section 19b is substantially the same as that of the LED attachment section 19a. The front surface of the heat dissipating section 19b, or in other words, the surface opposite to the side that is in contact with the chassis 14 faces the protruding member 21 of the frame 13, which will be later described. That is, the heat dissipating section 19b is interposed between the protruding member 21 of the frame 13 and the chassis 14. The heat dissipating section 19b makes surface-to-surface contact with not only the chassis 14, but also the protruding member 21, and heat from the LEDs 17 can thereby be transferred to the frame 13 having the protruding member 21. The heat dissipating section 19b is configured to be affixed to the protruding member 21 by a screw SM, and has an insertion hole 19b1 where the screw SM goes through. The heat dissipating section 19b protrudes from the rear edge, or in other words, the edge closer to the chassis 14 of the LED attachment section 19a toward the outside, or in other words, in the direction opposite to the light guide plate 16.

Next, the configurations of the frame 13 and the chassis 14 that constitute the exterior members will be explained. The frame 13 and the chassis 14 are both made of a metal such as aluminum, for example, and have higher mechanical strength (rigidity) and heat conductivity than a frame 13 and a chassis 14 that are made of a synthetic resin. As shown in FIG. 3, the frame 13 and the chassis 14 hold the liquid crystal panel 11, the optical members 15, and the light guide plate 16, which are stacked on top of the other, by sandwiching these stacked components from the front side and the rear side, while housing the pair of LED units LU on the respective edges in the shorter side direction.

As shown in FIG. 3, the frame 13 is formed in a horizontally-long frame shape as a whole so as to surround the display region on the display surface 11c of the liquid crystal panel 11. The frame 13 is constituted of a panel pressing portion 13a that is disposed in parallel with the display surface 11c of the liquid crystal panel 11 and that presses the liquid crystal panel 11 from the front side, and side walls 13b that protrude from the outer edges of the panel pressing portion 13a toward the rear side, and has a substantially L-shaped cross section. The panel pressing portion 13a is formed in a horizontally-long frame shape as in the outer edge portion (non-display region, frame portion) of the liquid crystal panel 11, and can press almost the entire outer edges of the liquid crystal panel 11 from the front side. The panel pressing portion 13a is made to be wide enough to cover the respective longer sides of the light guide plate 16 that are located outside of the respective longer sides of the liquid crystal panel 11 in the Y axis direction, and the respective LED units LU from the front side in addition to the outer edges of the liquid crystal panel 11. The front outer surface of the panel pressing portion 13a (surface opposite to the side facing the liquid crystal panel 11) is exposed to the outside on the front side of the liquid crystal display device 10 as in the display surface 11c of the liquid crystal panel 11, and constitutes the front side of the liquid crystal display device 10 together with the display surface 11c of the liquid crystal panel 11. On the other hand, the side walls 13b take the form of a substantially angular enclosure that rises from the outer edges of the panel pressing portion 13a toward the rear side. The side walls 13b can enclose the liquid crystal panel 11, the optical members 15, the light guide plate 16, and the LED units LU that are housed therein along almost the entire periphery thereof, and also can enclose the chassis 14 on the rear side along almost the entire periphery thereof. The outer surfaces of the side walls 13b along the circumference direction of the liquid crystal display device 10 are exposed to the outside in the circumference direction of the liquid crystal display device 10, and constitute the top face, the bottom face, and the side faces of the liquid crystal display device 10.

As shown in FIG. 4, in a pair of longer side portions of the panel pressing portion 13a having a horizontally-long frame shape, protruding members 21 for attaching the LED units LU are integrally formed in positions further back from the side walls 13b (closer to the light guide plate 16). The protruding members 21 protrude from the respective longer side portions of the panel pressing portion 13a toward the rear side along the Z axis direction, and are each formed in a substantially block shape that is horizontally long and that extends along the longer side direction (X axis direction). The protruding members 21 are respectively interposed between the side walls 13b of the frame 13 and the LED attachment sections 19a of the heat dissipating members 19 of the LED units LU. In the Z axis direction, the protruding member 21 is interposed between the panel pressing portion 13a of the frame 13 and the chassis 14. The protruding member 21 has a groove 21a formed therein that opens toward the rear side and that is used for attaching a screw (holding member) SM with which the LED unit LU and the like are affixed. The groove 21a is formed over the substantially entire length of the protruding member 21 along the longitudinal direction (X axis direction).

As shown in FIG. 4, in the respective longer side portions of the panel pressing portion 13a, positioning portions 22 that can engage the LED attachment sections 19a of the heat dissipating members 19 of the respective LED units LU are formed in positions further back from the respective protruding members 21 (closer to the light guide plate 16). The positioning portions 22 are formed by making a groove-shaped recess in the inner surfaces (rear surfaces) in the respective longer side portions of the panel pressing portion 13a, and the width thereof is slightly greater than the thickness of the LED attachment section 19a. By the positioning portions 22 engaging the LED attachment sections 19a, respectively, the LED units LU and the light guide plate 16 are positioned with respect to each other in the Y axis direction. The positioning portion 22 is formed to be long enough to allow the entire LED attachment section 19a to be inserted therein.

As shown in FIG. 4, in the respective longer side portions of the panel pressing portion 13a, light-shielding supporting portions 23 are respectively formed integrally with the panel pressing portion 13a in positions further back from the respective positioning portions 22 (closer to the light guide plate 16). The light-shielding supporting portions 23 are to be interposed between the liquid crystal panel 11 and the LEDs 17. The light-shielding supporting portions 23 respectively protrude from the respective longer side portions of the panel pressing portion 13a toward the rear side, and are each formed in a substantially block shape that is horizontally long and that extends along the longer side direction (X axis direction). By blocking a space between the LEDs 17 and the respective end faces of the liquid crystal panel 11 and optical members 15 that face the LEDs 17, the light-shielding supporting portion 23 prevents light from the LEDs 17 from directly entering the respective end faces of the liquid crystal panel 11 and the optical members 15 without passing through the light guide plate 16. That is, the light-shielding supporting portion 23 has the so-called light-shielding function. The light-shielding supporting portions 23 are configured such that the protrusion end faces thereof make contact with respective portions of the light guide plate 16 that protrude beyond the liquid crystal panel 11 and the optical members 15 toward the LEDs 17. Therefore, the light-shielding supporting portion 23 can support the light guide plate 16 by sandwiching the light guide plate 16 with the chassis 14 described below. The light-shielding supporting portion 23 makes contact with a portion of the light guide plate 16 at each edge (longer side edge) having the light-receiving surface 16b facing the LEDs 17. Therefore, by supporting the light guide plate 16 with the light-shielding supporting portions 23, a stable positional relationship between the LEDs 17 and the light-receiving surfaces 16b can be maintained with respect to the Z axis direction. The light-shielding supporting portions 23 are each formed so as to cover a longer side edge of the light guide plate 16 and a longer side edge of the bottom plate 14a of the chassis 14 in a plan view (when viewed from the display surface 11c) with respect to the Y axis direction (direction along which the LEDs 17 and the liquid crystal panel 11 are aligned), and in addition, so as to protrude from the light-receiving surface 16b of the light guide plate 16 toward the LEDs 17. On a surface of each light-shielding supporting portion 23 facing the liquid crystal panel 11, a buffer member 23a is provided, and the buffer member 23a can receive the end face of the liquid crystal panel 11. In the assembly process, the buffer members 23a allow the liquid crystal panel 11 to be properly positioned with respect to the direction along the display surface 11a thereof.

As shown in FIG. 4, in the inner edge of the panel pressing portion 13a, pressing protrusions 24 protruding toward the rear side, or in other words, toward the liquid crystal panel 11, are formed integrally with the panel pressing portion 13a. Buffer members 24a are attached to the protrusion end faces of the pressing protrusions 24, and the pressing protrusions 24 can press the liquid crystal panel 11 via the buffer members 24a from the front side. The pressing protrusions 24 are respectively formed in the two longer side portions and the two shorter side portions in the panel pressing portion 13a.

As shown in FIGS. 3 to 5, the chassis 14 is formed in a substantially shallow plate shape that is horizontally long as a whole so as to almost entirely cover the light guide plate 16, the LED units LU, and the like from the rear side. The rear outer surface of the chassis 14 (surface opposite to the side facing the light guide plate 16 and the LED units LU) is exposed to the outside on the rear side of the liquid crystal display device 10, and constitutes the rear side of the liquid crystal display device 10. The chassis 14 is constituted of a bottom plate 14a formed in a horizontally-long quadrangular shape as in the light guide plate 16, and a pair of side walls 14b that rise from a pair of longer side edges of the bottom plate 14a toward the front side. The bottom plate 14a is formed in a flat plate shape that has substantially the same size as the frame 13 in a plan view. The center portion in the shorter side direction thereof is a light guide plate receiving portion 14a1 that receives the entire light guide plate 16 (reflective sheet 20) from the rear side, and the respective edge portions in the shorter side direction are LED unit receiving portions 14a2 that respectively receive the pair of LED units LU.

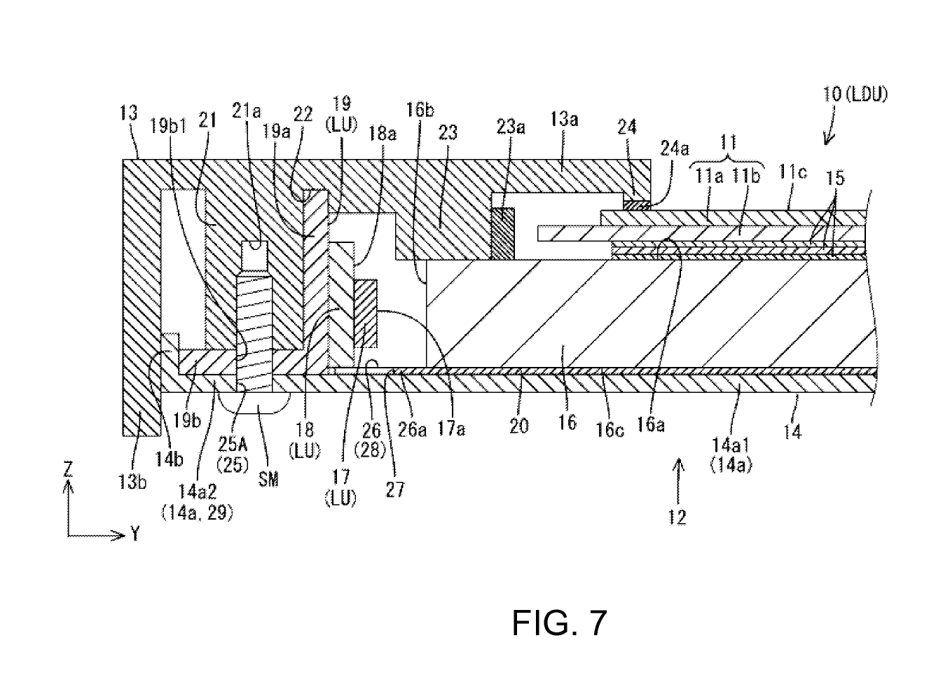

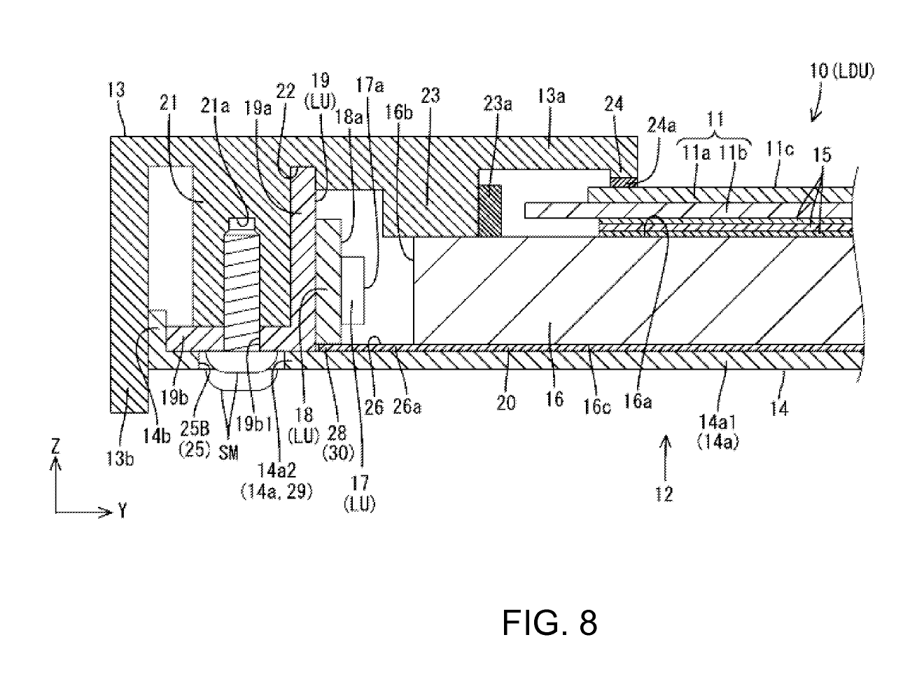

As shown in FIG. 4, the heat dissipating section 19b of the heat dissipating member 19 constituting a part of the LED unit LU is attached to the LED unit receiving portion 14a2 so as to make surface-to-surface contact with the front surface thereof. Insertion holes 25 are formed in the LED unit receiving portions 14a2, and these insertion holes are where the screws SM are held to attach the heat dissipating sections 19b and LED unit receiving parts 14a2 to the protruding members 21, respectively. The insertion holes 25 include an insertion hole 25A for jointly fastening a plurality of parts that is only large enough to allow the shaft portion of the screw SM to pass through as shown in FIG. 7, and an insertion hole 25B for the heat dissipating member that is large enough to allow not only the shaft portion, but also the head of the screw SM to pass through as shown in FIG. 8. The screw SM going through the former fastens both of the heat dissipating section 19b and the LED unit receiving portion 14a2 to the protruding member 21, while the screw SM going through the latter fastens only the heat dissipating section 19b to the protruding member 21.

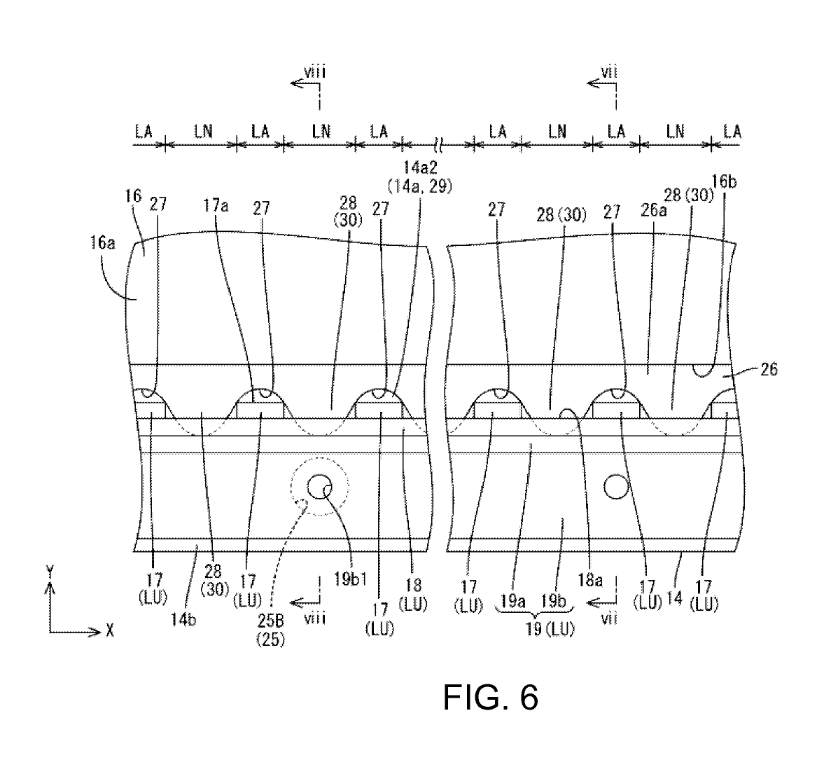

As shown in FIGS. 6 and 7, in the extended reflective part 26 that is a part of the reflective sheet 20 of the present embodiment, openings 27 are formed so as to correspond to the arrangement pattern of the LEDs 17. Therefore, the remaining portion of the extended reflective part 26 where the openings 27 are not formed (portion where the openings are not formed) has a shape that corresponds to the non-arrangement pattern of the LEDs 17. The “arrangement pattern of LEDs 17” refers to areas LA where the light sources are arranged (light-source overlapping areas that overlap (correspond in position to) the respective LEDs 17 with respect to the arrangement direction of the LEDs 17). On the other hand, the “non-arrangement pattern of the LEDs 17” refers to areas LN where the light sources are not arranged (light-source non-overlapping areas that do not overlap (do not correspond in position to) the respective LEDs 17 with respect to the arrangement direction of the LEDs 17). The areas LN where the light sources are not arranged include areas between respective adjacent LEDs 17 in the arrangement direction of the LEDs 17, and areas that are respectively adjacent to the two LEDs 17 at the respective ends in the arrangement direction of the LEDs 17 and that are respectively closer to the respective ends than the two LEDs 17 (opposite to respective adjacent LEDs 17 that are closer to the center than the respective two LEDs 17 at the ends).

More specifically, as shown in FIGS. 6 and 7, the extended reflective part 26 extends from the light-receiving surface 16b of the light guide plate 16 toward the outside, or toward the LEDs 17 along the Y axis direction (direction along which the LEDs 17 and the light-receiving surface 16b are aligned), and the extended edge face thereof passes the LED substrate 18 and reaches an area near the surface of the heat dissipating member 19 on which the LED substrate 18 is attached. Thus, the extended edge face of the extended respective part 26 is sandwiched by the rear end face of the LED substrate 18 and the LED unit receiving portion 14a2 of the bottom plate 14a of the chassis 14. In the extended reflective part 26, an opening 27 is formed in an area from the primary light-emitting surface 17a of each LED 17 to the extended edge face thereof along the extension direction (Y axis direction). Therefore, in the extended reflective part 26, an extended base section 26a, which covers an area from the light-receiving surface 16b to a point near the primary light-emitting surface 17a of each LED 17 along the extension direction, extends along the X axis direction without having cut-out portions (openings 27) in the entire length thereof. On the other hand, a section of the extended reflective part 26 located closer to the extended edge has cut-out portions in places, which are the openings 27, and the remaining portions form protruding tabs 28.

As shown in FIG. 6, in the extended reflective part 26, a plurality of the openings 27 are arranged at intervals along the X axis direction, or in other words, the direction in which the LEDs 17 are aligned. A plurality of the protruding tabs 28 are arranged at intervals along the X axis direction, and one opening 27 is disposed between two adjacent protruding tabs 28. That is, the openings 27 and the protruding tabs 28 are alternately aligned along the X axis direction. As a result, the extended edge face of the extended reflective part 26 has protrusions and recesses that repeat periodically along the X axis direction (waveform). Specifically, the extended edge face of the extended reflective part 26 has a sinusoidal wave shape in a plan view, and therefore, edges of the respective openings 27 (edges of the respective protruding tabs 28), which constitute the extended edge face of the extended reflective part 26, each have a substantially arc shape in a plan view. Each opening 27 and each protruding tab 28 have a substantially bell-like shape in a plan view, which is symmetric with respect to the X axis direction, respectively. Each opening 27 and each protruding tab 28 are line-symmetric with each other, and the respective areas thereof are substantially the same as each other. Each opening 27 is formed such that the area thereof gradually decreases in a direction from the LEDs 17 (LED substrate 18, heat dissipating member 19) toward the light guide plate 16, and conversely, the area thereof gradually increases in a direction from the light guide plate 16 toward the LEDs 17 (LED substrate 18, heat dissipating member 19). On the other hand, each protruding tab 28 is formed such that the area thereof gradually increases in a direction from the LEDs 17 (LED substrate 18, heat dissipating member 19) toward the light guide plate 16, and conversely, the area thereof gradually decreases in a direction from the light guide plate 16 toward the LEDs 17 (LED substrate 18, heat dissipating member 19).

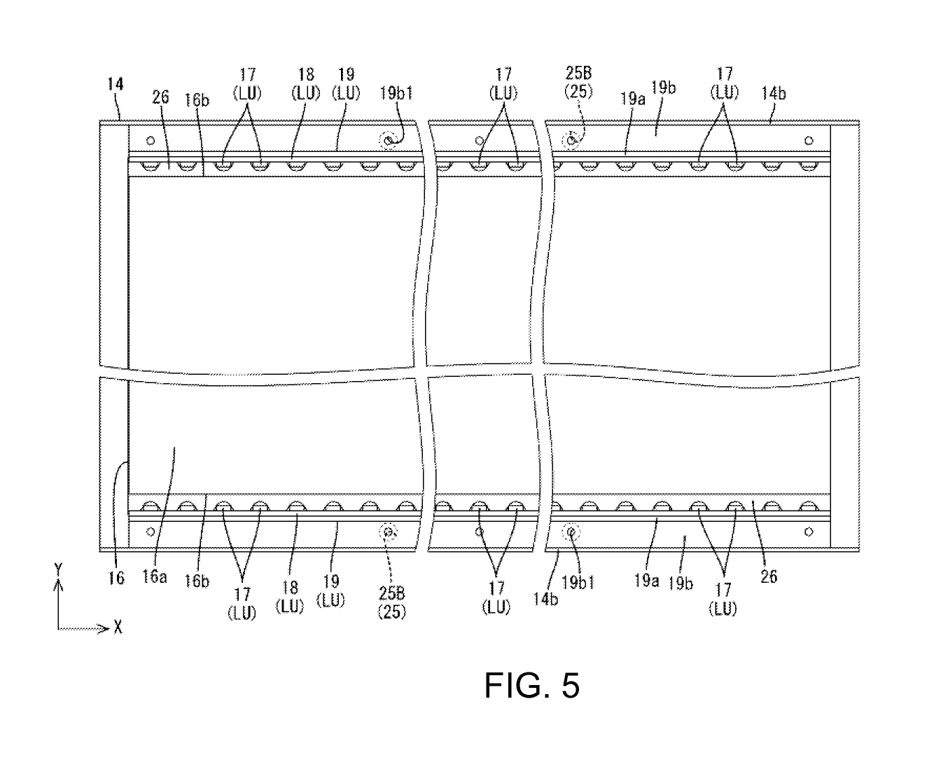

As shown in FIGS. 5 and 6, the plurality of openings 27 arranged along the X axis direction are disposed such that the arrangement pitch thereof is substantially the same as the arrangement pitch of the respective LEDs 17, such that the respective openings 27 share the same centers with the respective LEDs 17 with respect to the X axis direction, and such that the number thereof is the same as the number of the LEDs 17. Therefore, the respective openings 27 are arranged in substantially the same manner as the respective LEDs 17, and areas where the respective openings 27 are formed correspond to the respective areas LA where the light sources are arranged (arrangement pattern of the LEDs 17). As shown in FIG. 6, each opening 27 is formed to be greater than an LED 17 in a plan view, and corresponds in position to the entire area of an LED 17 in a plan view (when viewed from the display surface 11c). Each opening 27 is formed such that an edge thereof touches the respective corners of an LED 17. As shown in FIG. 7, when the respective openings 27 are formed in the extended reflective part 26, portions of the LED unit housing portion 14a2 of the bottom plate 14a of the chassis 14 that is disposed on the rear side of the extended reflective part 26 are exposed toward the LEDs 17 through the respective openings 27. The surfaces of the exposed portions of the chassis 14 have a lower light reflectance than the reflective sheet 20 because the chassis 14 is made of a metal. Therefore, the portions of the bottom plate 14a of the chassis 14 that are exposed through the respective openings 27 are lower light reflectance portions 29 that have a lower light reflectance than the extended reflective part 26.

On the other hand, as shown in FIGS. 5 and 6, the protruding tabs 28 are adjacent to the respective openings 27 along the X axis direction, and therefore, the arrangement pitch thereof corresponds to the arrangement pitch of the respective LEDs 17. Among the protruding tabs 28, each protruding tab 28 that is interposed between two adjacent openings 27 has the center position in the X axis direction substantially matching the middle position between adjacent LEDs 17. Therefore, the respective protruding tabs 28 are offset from the respective LEDs 17 in the X axis direction, and correspond to the areas LN where the light sources are not arranged (non-arrangement pattern of the LEDs 17). Each protruding tab 28 is positioned so as not to overlap an LED 17 at all in a plan view. Each protruding tab 28 is a portion of the reflective sheet 20, and therefore, the light reflectance on the surface thereof is higher than the light reflectance of the portions of the bottom plate 14a (lower light reflectance portions 29) in the chassis 14 that are exposed through the respective openings 27, or in other words, each protruding tab 28 is a higher light reflectance portion 30. As shown in FIGS. 6 and 8, each protruding tab 28 is formed in an area from the extension base section 26a of the extended reflective part 26 to the surface of the heat dissipating member 19 to which the LED substrate 18 is attached in the Y axis direction, and the edge thereof is sandwiched between the LED substrate 18 and the bottom plate 14a of the chassis 14.

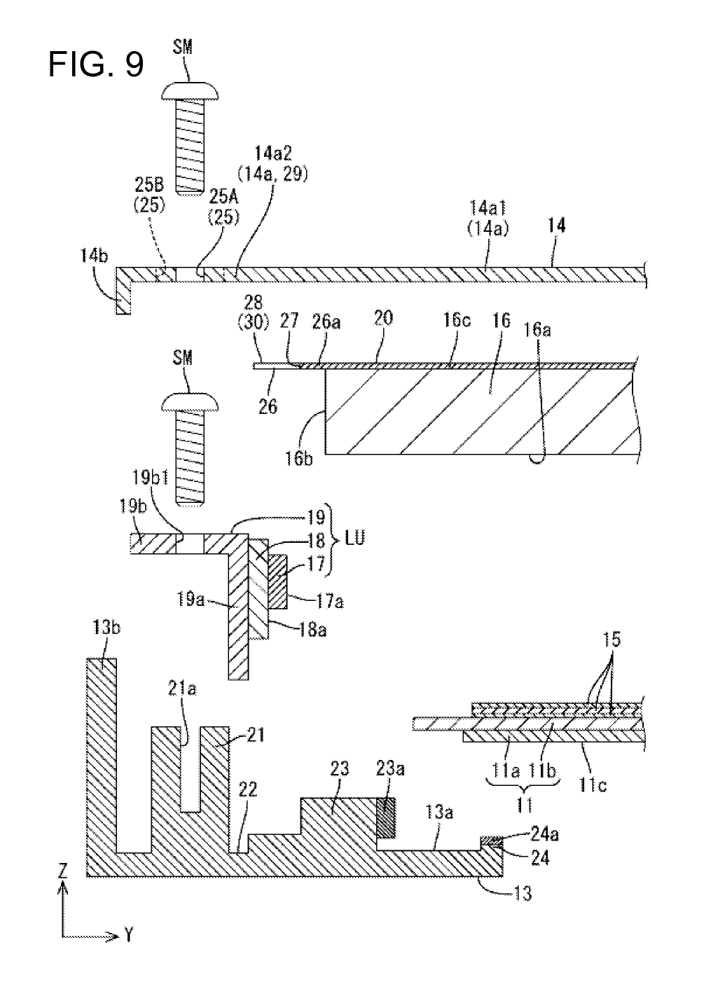

The present embodiment has the above-mentioned structure, and the operation thereof will be explained next. The liquid crystal display device 10 is manufactured by assembling respective constituting components that are manufactured separately (frame 13, chassis 14, liquid crystal panel 11, optical members 15, light guide plate 16, LED units LU, and the like) together. In the assembly process, the respective constituting components are assembled after being flipped over with respect to the Z axis direction from the position shown in FIGS. 4 and 7. First, as shown in FIG. 9, the frame 13 among the constituting components is set on a not-shown work table such that the rear side thereof faces up in the vertical direction.

On the frame 13 that has been set with the orientation described above, as shown in FIG. 9, the liquid crystal panel 11 is placed with the CF substrate 11a down and the array substrate 11b up in the vertical direction. The front surface of the liquid crystal panel 11 is received by the buffer member 24a attached to the pressing protrusion 24 of the frame 13, and the end faces thereof are received by the buffer members 23a attached to the light-shielding supporting portions 23 of the frame 13, thereby absorbing shock and accurately positioning the liquid crystal panel 11 with respect to the X axis direction and the Y axis direction. Next, the respective optical members 15 are directly stacked on the rear side of the liquid crystal panel 11 in an appropriate order.

On the other hand, as shown in FIG. 9, the LED units LU each having the LEDs 17, the LED substrate 18, and the heat dissipating member 19 assembled together are attached to the frame 13. The LED units LU are respectively attached to the protruding members 21 of the frame 13 such that the LEDs 17 are oriented toward the center (inner side) of the frame 13, and such that the heat dissipating sections 19b of the heat dissipating members 19 face the protruding members 21, respectively. In this assembly process, the front side edge of the LED attachment section 19a of the heat dissipating member 19 engages the positioning portion 22 that takes the form of a groove, and the LED unit LU is thereby positioned with respect to the frame 13 in the Y axis direction. When the LED units LU are attached, the LED attachment sections 19a and the heat dissipating sections 19b of the respective heat dissipating members 19 respectively make surface-to-surface contact with the protruding members 21. Also, in this state, the LED units LU are positioned such that respective insertion holes 19b1 of the heat dissipating sections 19b are connected to the grooves 21a of the protruding members 21, respectively. Next, the screws SM are inserted through the corresponding insertion holes 19b1 in the heat dissipating section 19b, and screwed into the grooves 21a of the protruding members 21, respectively. With the screws SM, the LED units LU are affixed to the protruding members 21 in the stage before the chassis 14 is attached in a manner described below (see FIG. 8).

After the above-mentioned assembly process of the LED units LU, the light guide plate 16 having the reflective sheet 20 attached thereto in advance is directly stacked on the rear surface of the rearmost member of the optical members 15. The respective longer side edges of the light guide plate 16 are supported by the light-shielding supporting portions 23 of the frame 13, respectively. The reflective sheet 20 is manufactured by rolling out a base material coil and stamping the base material with die, and is then attached to the light guide plate 16. Therefore, there is a possibility that warping from the coil remains therein. If this warping remains in the respective longer side edges of the reflective sheet 20, or in other words, in the respective extended reflective parts 26, it is possible that the deformed extended reflective part 26 enters a space between the LEDs 17 and the light-receiving surface 16b of the light guide plate 16. On the other hand, because the extended reflective part 26 of the present embodiment has the openings 27 formed therein that correspond to the arrangement pattern of the LEDs 17, even if the extended reflective part 26 is deformed or warped, the extended reflective part 26 is less likely to enter the space between the LEDs 17 and the light-receiving surface 16b of the light guide plate 16. Even if the extended reflective part 26 enters the space, a portion thereof entering the space will be small. This makes it possible to prevent the extended reflective part 26 from blocking light emitted from the LEDs 17. The timing at which the LED units LU are attached to the frame 13 may be appropriately modified, and the LED units LU may be attached before the optical members 15 are attached or the liquid crystal panel 11 is attached.

After attaching the liquid crystal panel 11, the optical members 15, the light guide plate, and the LED units LU to the frame 13 as described above, a process to attach the chassis 14 is conducted. As shown in FIG. 9, the chassis 14 is attached to the frame 13 with the front side thereof down in the vertical direction. By having the respective side walls 14b of the chassis 14 make contact with the inner surfaces of the side walls 13b on the respective longer sides of the frame 13, the chassis 14 can be positioned to the frame 13. In the assembly process, the heads of the respective screws SM attached in advance to the heat dissipating members 19 and protruding members 21 pass through the insertion holes 25B for the heat dissipating members in the LED unit receiving portions 14a2 of the bottom plate 14a of the chassis 14 (see FIG. 8). Then, when the light guide place receiving portion 14a1 of the bottom plate 14a of the chassis 14 makes contact with the light guide plate 16 (reflective sheet 20) and the respective LED unit receiving portions 14a2 make contact with the heat dissipating sections 19b of the respective heat dissipating members 19, screws SM are inserted through the insertion holes 25A for jointly fastening a plurality of parts, and screwed into the grooves 21a of the protruding members 21. With the screws SM, the LED units LU and the chassis 14 are affixed to the protruding members 21 (see FIG. 7). In this assembly state, the extended edge of each extended reflective part 26 (each protruding tab 27) of the reflective sheet 20 is sandwiched between the LED substrate 18 and the LED unit receiving portion 14a2 of the bottom plate 14a of the chassis 14, and therefore, even if the extended reflective part 26 has deformation such as warping, the extended reflective part 26 is straightened up along the bottom plate 14a. This makes it possible to prevent the extended reflective part 26 that includes edges of the respective openings 27 from entering the space between the LEDs 17 and the light-receiving surface 16b of the light guide plate 16 more reliably.

The assembly of the liquid crystal display unit LDU is completed in the manner described above. Next, after the stand attachment members STA and various boards PWB, MB, and CTB are attached to the rear side of the liquid crystal display unit LDU, the stand ST and the cover member CV are attached to the rear side, thereby completing the liquid crystal display device 10 and the television receiver TV. In the liquid crystal display device 10 manufactured in this manner, the exterior thereof is constituted of the frame 13 that presses the liquid crystal panel 11 from the display surface 11c side, and the chassis 14 of the backlight device 12, and the liquid crystal panel 11 is directly stacked on the optical members 15. Therefore, as compared with a conventional configuration in which a cabinet made of a synthetic resin is provided in addition to the frame 13 and the chassis 14, or in which a member is provided between the liquid crystal panel 11 and the optical members 15 so as to keep the two from making contact with each other, the number of parts and the assembly man-hour can be reduced, resulting in a lower manufacturing cost, and the size and weight reduction.

When the liquid crystal display device 10 manufactured as described above is turned on, as shown in FIG. 4, power is supplied from the power supply board PWB, causing various signals to be sent from the control board CTB to the liquid crystal panel 11, and the drive of the liquid crystal panel 11 is controlled and the respective LEDs 17 of the backlight device 12 are driven. By passing through the optical members 15 after being guided by the light guide plate 16, light from the respective LEDs 17 is converted to even planar light, which then illuminates the liquid crystal panel 11, and a prescribed image is displayed on the liquid crystal panel 11. To explain the operation of the backlight device 12 in detail, when the respective LEDs 17 are lit, light emitted from the respective LEDs 17 enters the light-receiving surface 16b of the light guide plate 16 that faces the LEDs 17 as shown in FIG. 7. In the process of travelling through the light guide plate 16 while being subject to the total reflection at the interfaces between the light guide plate 16 and external air spaces, being reflected by the reflective sheet 20, and the like, the light that entered the light-receiving face 16b is reflected or diffused by not-shown reflective portions and diffusion portions, thereby being outputted from the light-emitting surface 16a and being radiated to the optical members 15.

The amount of light that enters the light-receiving surfaces 16b of the light guide plate 16 sometimes becomes uneven due to the arrangement pattern and the non-arrangement pattern of the plurality of LEDs 17 arranged at intervals. Portions of the light-receiving surface 16b that face the LEDs 17, or in other words, portions in the areas LA where the light sources arranged, which correspond in position to the LEDs 17 with respect to the direction along which the LEDs 17 are aligned, receive more of the light emitted from the LEDs 17, than portions of the light-receiving surface 16b that do not face the LEDs 17, or in other words, portions in the areas LN where the light sources are not arranged, which do not correspond in position to the LEDs 17 with respect to the direction along which the LEDs 17 are aligned (see FIG. 6). Therefore, the amount of light that enters the light-receiving surfaces 16b becomes uneven, which possibly causes uneven brightness of light that is emitted from the light-emitting surface 16a. In particular, when the distance between the LEDs 17 and each light-receiving surface 16b is made smaller, in order to achieve a narrower frame in the liquid crystal display device 10 and the backlight device 12, light from the LEDs 17 is incident on the light-receiving surfaces 16b more directly, and the above-mentioned unevenness tends to be more pronounced. “To achieve a narrower frame” means to reduce the width of non-light-emitting frame portion of the liquid crystal display device 10 and the backlight device 12, and because the edges having the LED units LU and the light-receiving surfaces 16b of the light guide plate 16 are disposed in this frame portion, the above-mentioned problem occurs.

In the present embodiment, as shown in FIGS. 6 to 8, the openings 27 corresponding to the arrangement pattern of the LEDs 17 are formed in the extended reflective parts 26 of the reflective sheet 20, which respectively extend from the light-receiving surfaces 16b of the light guide plate 16 toward the LEDs 17, and the protruding tabs 28, which are constituted of the remaining portions of the extended reflective parts 26, are disposed so as to correspond to the non-arrangement pattern of the LEDs 17. Specifically, by forming the plurality of openings 27 at intervals in the extended edge portion of each extended reflective part 26 along the X axis direction (direction along which the LEDs 17 are aligned) such that the arrangement of the openings 27 in the X axis direction corresponds to the areas LA where the light source are arranged, which is the arrangement pattern of the LEDs 17, the protruding tabs 28 constituted of the remaining portions of the extended edge portion are arranged so as to correspond in position to the areas LN where the light sources are not arranged, which is the non-arrangement pattern of the LEDs 17, in the X axis direction. In this configuration, as shown in FIG. 7, in the areas LA where the light sources are arranged and where the amount of light is relatively large, light that goes toward the chassis 14 in the process of travelling from the LEDs 17 to the light-receiving surface 16b hits the portions of bottom plate 14a of the chassis 14 that are exposed through the openings 27, i.e., the lower light reflectance portions 29, and therefore, the light enters the light-receiving surface 16b without being reflected excessively. On the other hand, as shown in FIG. 8, in the areas LN where the light sources are not arranged and where the amount of light is relatively small, light that goes toward the chassis 14 in the process of travelling from the LEDs 17 to the light-receiving surface 16b hits the protruding tabs 28 that are portions of the reflective sheet 20, i.e., the higher light reflectance portions 30, and therefore, the light enters the light-receiving surface 16b after undergoing highly efficient light reflection. As a result, the amount of light that enters the light-receiving surfaces 16b of the light guide plate 16 evens out regardless of the arrangement pattern (areas LA where the light sources are arranged) and the non-arrangement pattern (areas LN where the light sources are not arranged) of the plurality of LEDs 17 arranged at intervals. The openings 27 are formed in the entire area that overlap the LEDs 17 in a plan view, have a symmetric shape with respect to the X axis direction, are positioned so as to share the same centers as the respective LEDs 17, and are formed in a substantially bell-like shape such that the area thereof gradually decreases in the direction from the LEDs 17 toward the light guide plate 16. This makes it possible to further suppress unevenness in the amount of light that enters the light-receiving surfaces 16b.

The extended edge of the extended reflective part 26 (protruding tabs 27) is sandwiched between the LED substrate 18 and the bottom plate 14a of the chassis 14, and therefore, even if the extended reflective part 26 is warped, the warping can be removed, and the extended reflective part 26 including edges of the respective openings 27 can be prevented from entering the space between the LEDs 17 and the light-receiving surface 16b of the light guide plate 16. Furthermore, even if the warping still remains in the extended reflective part 26, because of the openings 27 formed in the extended reflective part 26 so as to correspond to the arrangement pattern of the LEDs 17 (areas LA where the light sources are arranged), the deformed extended reflective part 26 is less likely to enter the space between the LEDs 17 and the light-receiving surface 16b of the light guide plate 16. Even if the extended reflective part 26 enters the space, a portion thereof entering the space will be small. The above-mentioned configuration makes it difficult for the extended reflective part 26 to block the light emitted from the LEDs 17 and travelling toward the light-receiving surface 16b. Thus, it is possible to suppress a reduction in the amount of light that enters the light-receiving surfaces 16b, or in other words, to suppress a reduction in brightness of light that is emitted from the light-emitting surface 16a.

As described above, the backlight device (illumination device) 12 of the present embodiment includes: a plurality of LEDs (light sources) 17 arranged at intervals; the light guide plate 16 having the light-receiving surfaces 16b that are disposed to face the LEDs 17 and that receive light from the LEDs 17, and the light-emitting surface 16a through which light that entered the light guide plate is emitted; the reflective sheet (reflective member) 20 disposed to cover a surface of the light guide plate 16 opposite to the light-emitting surface 16a, the reflective sheet 20 reflecting light toward the light-emitting surface 16a; and the extended reflective parts 26 constituted of the respective edges of the reflective sheet 20, the extended reflective parts extending from the respective light-receiving surfaces 16b toward the LEDs 17, the extended reflective parts each having a shape that corresponds to a non-arrangement pattern of the LEDs 17 (areas LN where the light sources are not arranged) by having the openings 27 formed therein that correspond to the arrangement pattern of the LEDs 17 (areas LA where the light sources are arranged).

With this configuration, light emitted from the plurality of LEDs 17 is reflected by the reflective sheet 20 toward the light-emitting surface 16a in the process of travelling through the light guide plate 16 after entering the light-receiving surfaces 16b of the light guide plate 16 that are respectively disposed to face the LEDs 17, and is thereby emitted from the light-emitting surface 16a efficiently. The edges of the reflective sheet 20 are the extended reflective parts 26 that extend respectively from the light-receiving surfaces 16b to the LEDs 17, and the extended reflective parts 26 each having a shape that corresponds to the non-arrangement pattern of the LEDs 17 by having the openings 27 formed therein that correspond to the arrangement pattern of the LEDs 17. Therefore, while the light from the LEDs 17 travels toward the light-receiving surfaces 16b, the openings 27 that correspond to the arrangement pattern of the LEDs 17 can mitigate reflection of light where light reflection tends to be excessive, and the extended reflective parts 26 that have a shape corresponding to the non-arrangement pattern of the LEDs 17 can improve reflection of light where light reflection tends to be insufficient. Thus, the amount of light that enters the light-receiving surfaces 16b of the light guide plate 16 evens out regardless of the arrangement pattern and the non-arrangement pattern of the plurality of LEDs 17 that are arranged at intervals. As a result, uneven brightness of light that is emitted from the light-emitting surface 16a of the light guide plate 16 is less likely to occur. In particular, when the distance between the LEDs 17 and each light-receiving surface 16b of the light guide plate 16 is made smaller, the uneven brightness is more likely to occur, and therefore, this configuration is useful in achieving a narrower frame in the backlight device 12.

In addition, even when the extended reflective part 26 is deformed due to warping and the like, because the extended reflective part 26 has the openings 27 formed therein that correspond to the arrangement pattern of the LEDs 17, the deformed extended reflective part 26 is less likely to enter a space between the LEDs 17 and the light-receiving surface 16b, and even if the extended reflective part 26 enters the space, a portion thereof entering the space will be small. This makes it difficult for the deformed extended reflective part 26 to block light from the LEDs 17, and this configuration is preferable in preventing the brightness reduction. As described above, according to the present embodiment, uneven brightness and brightness reduction can be suppressed.

The illumination device further includes: the LED substrate 18 on which the plurality of LEDs 17 are mounted; and the chassis 14 having the bottom plate 14a that is disposed on the reflective sheet 20 on a side opposite to the light guide plate 16, the chassis 14 housing the LED substrate 18, the light guide plate 16, and the reflective sheet 20, and the extended reflective parts 26 each extend to a position where the extended reflective part 26 is sandwiched between the LED substrate 18 and the bottom plate 14a of the chassis 14. With this configuration, by sandwiching the extended reflective part 26 between the LED substrate 18 and the bottom plate 14a of the chassis 14, even if the extended reflective part 26 is warping, the warping can be removed, which prevents deformation of the extended reflective part 26. This makes it even more difficult for the extended reflective part 26 to enter the space between the LEDs 17 and the light-receiving surface 16b, and this configuration is more preferable in achieving the brightness reduction.

The extended reflective part 26 is formed such that an extended edge face thereof has recesses and protrusions that repeat periodically in a direction along which the LEDs 17 are aligned, and a plurality of the openings 27 are arranged at intervals in the direction along which the LEDs 17 are aligned. In this configuration, the extended edge face of the extended reflective part 26 is not disposed where the LEDs 17 are arranged, as opposed to a configuration in which the extended edge face of the extended reflective part 26 having the openings 27 is a straight line and portions of the edge of the extended reflective part 26 are disposed where the LEDs 17 are arranged, and therefore, the light reflection at locations where the LEDs 17 arranged can be more effectively mitigated.

The openings 27 are formed in the entire area that overlaps the LEDs 17 in a plan view. In this configuration, because the openings 27 are formed in the entire area where most of the light emitted from the LEDs 17 is radiated, it is possible to effectively mitigate the light reflection that tends to be excessive at locations where the LEDs 17 are arranged, and thus, this configuration is more preferable in mitigating uneven brightness.

The openings 27 each have a symmetric shape with respect to the direction along which the LEDs 17 are aligned, and the LEDs 17 are each positioned so as to share the same center as one of the openings 27 with respect to the direction along which the LEDs 17 are aligned. With this configuration, the LEDs 17 are each positioned so as to share the same center as one of the openings 27 with respect to the direction along which the LEDs 17 are aligned, and the openings 27 each have a symmetric shape with respect to the direction along which the LEDs 17 are aligned. Therefore, the amount of light reflected by the extended reflective part 26 having the openings 27 formed therein is not likely to be uneven with respect to the direction along which the LEDs 17 are aligned, which makes this configuration more preferable in mitigating the uneven brightness.

The extended reflective part 26 is formed such that the area of each of the openings 27 becomes gradually smaller in a direction from the LEDs 17 toward the light guide plate 16, causing the area of the extended reflective part 26 to be gradually larger in the direction from the LEDs 17 toward the light guide plate 16. Light emitted from the LEDs 17 tends to spread and even out in a direction further away from the LEDs 17, and therefore, in this configuration, in locations closer to the LEDs 17, by having the light pass through the openings 27, the reflection of light is mitigated, which effectively mitigates the unevenness, while in locations further away from the LEDs 17, the light is reflected more efficiently by the extended reflective part 26, which increases the brightness. As a result, the uneven brightness can be mitigated even more effectively.

The extended reflective part 26 is formed such that an extended edge face thereof has a sinusoidal wave shape. With this configuration, it is possible to prevent the extended reflective parts 26 from being bent or warped when the reflective sheet 20 is manufactured, and because the extended reflective parts 26 are not susceptible to stress concentration, the extended reflective parts 26 are less susceptible to tear or break.

The LEDs 17 are used as the light sources. With this configuration, it is possible to achieve higher brightness, lower energy consumption, and the like.

### Embodiment 2

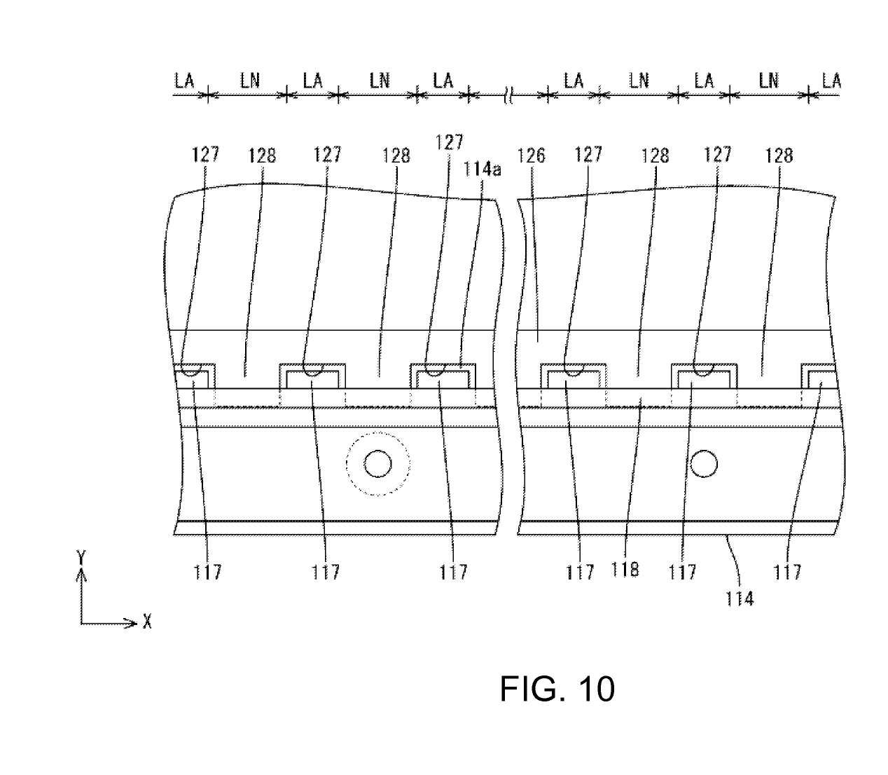

Embodiment 2 of the present invention will be described with reference to FIG. 10. In Embodiment 2, plan view shapes of openings 127 and protruding tabs 128 are modified. Descriptions of structures, operations, and effects similar to those of Embodiment 1 will be omitted.

As shown in FIG. 10, the extended reflective part 126 of the present embodiment has an extended edge face formed in a square wave shape in a plan view. The openings 127 formed in an extended edge portion of the extended reflective part 126 have a shape that corresponds to the outer shape of each LED 117 that is formed in a horizontally-long quadrangle (rectangle) in a plan view. That is, the openings 127 are each formed in a horizontally-long quadrangle that is slightly larger than the LED 117 in a plan view, and a distance (positional relationship) between the edge of the opening 127 and the outer surface of the LED 117 is substantially the same in the entire circumference. This makes it possible to suppress unevenness in the amount of light reflected by the protruding tabs 128 constituted of the remaining portions of the extended reflective part 126. The width dimensions of the openings 127 and the protruding tabs 128 with respect to the Y axis direction (direction in which the extended reflective part 126 extends) are constant over the entire length. The area of the portion of each protruding tab 128 that is sandwiched between an LED substrate 118 and a bottom plate 114a of a chassis 114 is greater than that of the protruding tab having a rounded shape as in Embodiment 1 above.

As described above, in the present embodiment, the openings 127 are formed in the shape corresponding to the outer shape of the LEDs 117. With this configuration, in the extended reflective part 126, the positional relationship between the edge of the opening 127 and the LED 117 is maintained constant in the circumference direction. Therefore, it is possible to suppress unevenness in the amount of light reflected by the extended reflective part 126 with respect to the circumference direction of the LED 117, which makes this configuration more preferable in suppressing uneven brightness.

### Embodiment 3

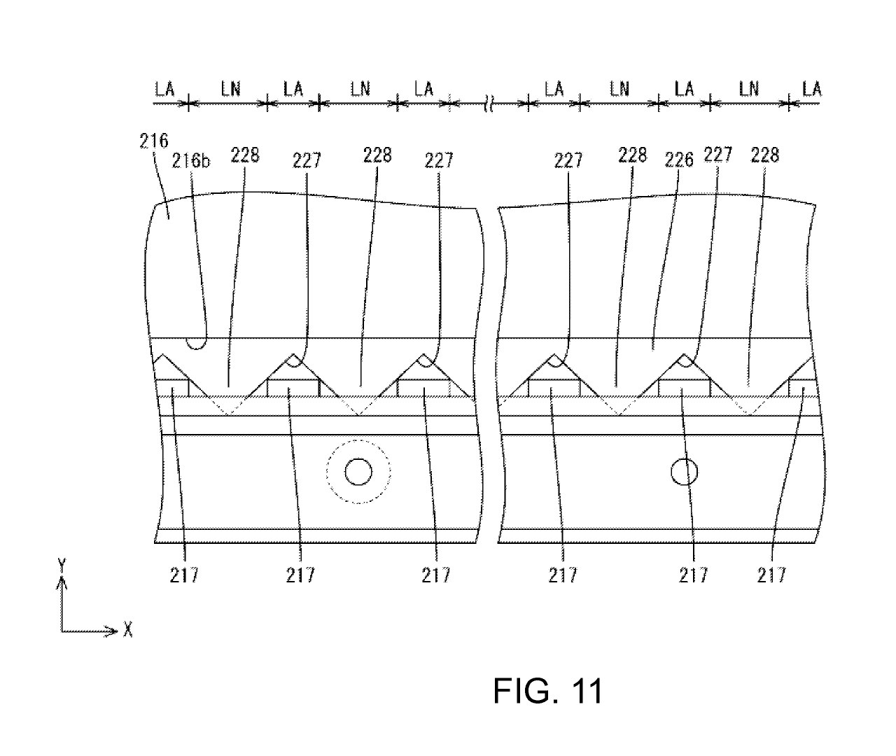

Embodiment 3 of the present invention will be described with reference to FIG. 11. In Embodiment 3, plan view shapes of openings 227 and protruding tabs 228 are modified. Descriptions of structures, operations, and effects similar to those of Embodiment 1 will be omitted.

As shown in FIG. 11, the extended reflective part 226 of the present embodiment has an extended edge face formed in a triangular wave shape in a plan view. The openings 227 formed in the extended edge portion of the extended reflective part 226 are each formed in an isosceles triangle in a plan view, and the edges thereof are inclined such that the opening area gradually decreases in the direction from LEDs 217 toward a light guide plate 216. Thus, the openings 227 are each formed such that the area thereof gradually decreases in the direction from the LEDs 217 toward the light guide plate 216. The openings 227 are each formed such that the respective inclined edges thereof respectively touch the two corners of an LED 217. The protruding tabs 228 remaining in the extended reflective part 226 are each formed in an isosceles triangle in a plan view as in the openings 227 such that the area thereof gradually increases in the direction from the LEDs 217 toward the light guide plate 216. With the protruding tabs 228 having such a configuration, the amount of light reflected thereby gradually increases in the direction from the LEDs 217 toward the light guide plate 216, and this configuration is more preferable in suppressing the uneven brightness.

As described above, in the present embodiment, the edges of each of the openings 227 are inclined such that the opening area thereof gradually decreases in the direction from LEDs 217 toward the light guide plate 216. By making the edges of the openings 227 inclined in this manner, the area of each opening 227 gradually decreases in the direction from the LEDs 217 toward the light guide plate 216. On the other hand, the area of the extended reflective part 226 gradually increases in the direction from the LEDs 217 toward the light guide plate 216. As a result, uneven brightness can be more effectively mitigated.

### Embodiment 4

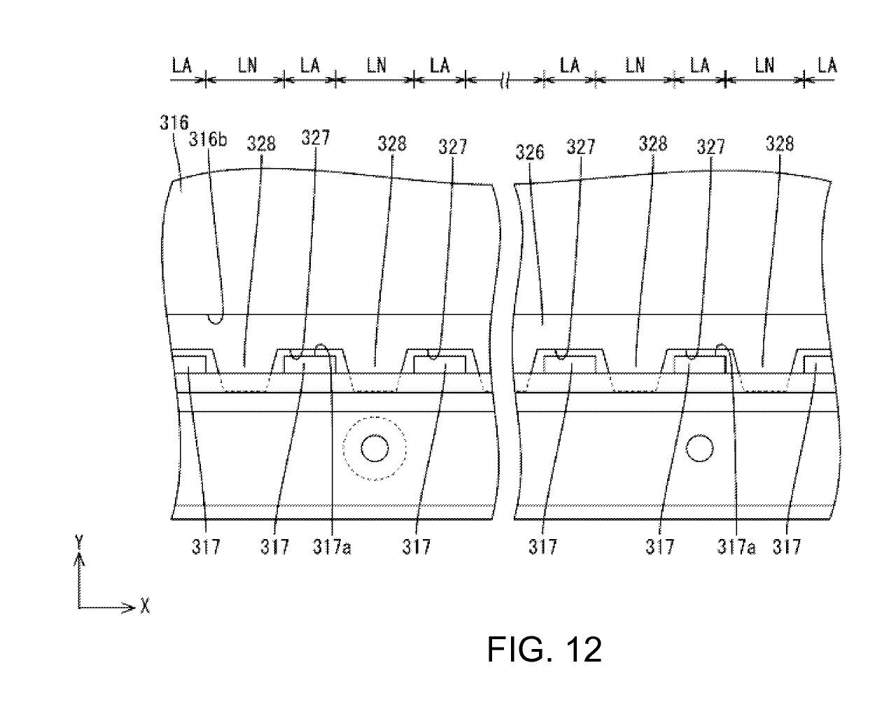

Embodiment 4 of the present invention will be described with reference to FIG. 12. In Embodiment 4, plan view shapes of openings 327 and protruding tabs 328 are modified. Descriptions of structures, operations, and effects similar to those of Embodiment 1 will be omitted.

As shown in FIG. 12, an extended reflective part 326 of the present embodiment has an extended edge face formed in a trapezoid wave shape in a plan view. The openings 327 formed in the extended edge portion of the extended reflective part 326 are each formed in an isosceles trapezoid in a plan view, and the edges thereof are inclined such that the opening area thereof gradually decreases in the direction from LEDs 317 toward a light guide plate 316. Thus, the openings 327 are each formed such that the area thereof gradually decreases in the direction from the LEDs 317 toward the light guide plate 316. Among the edges of each opening 327, an edge that connects a pair of inclined edges is parallel to a primary light-emitting surface 317a of an LED 317. The protruding tabs 328 remaining in the extended reflective part 326 are each formed in an isosceles triangle in a plan view as in the openings 327 such that the area thereof gradually increases in the direction from the LEDs 317 toward the light guide plate 316.

### Embodiment 5

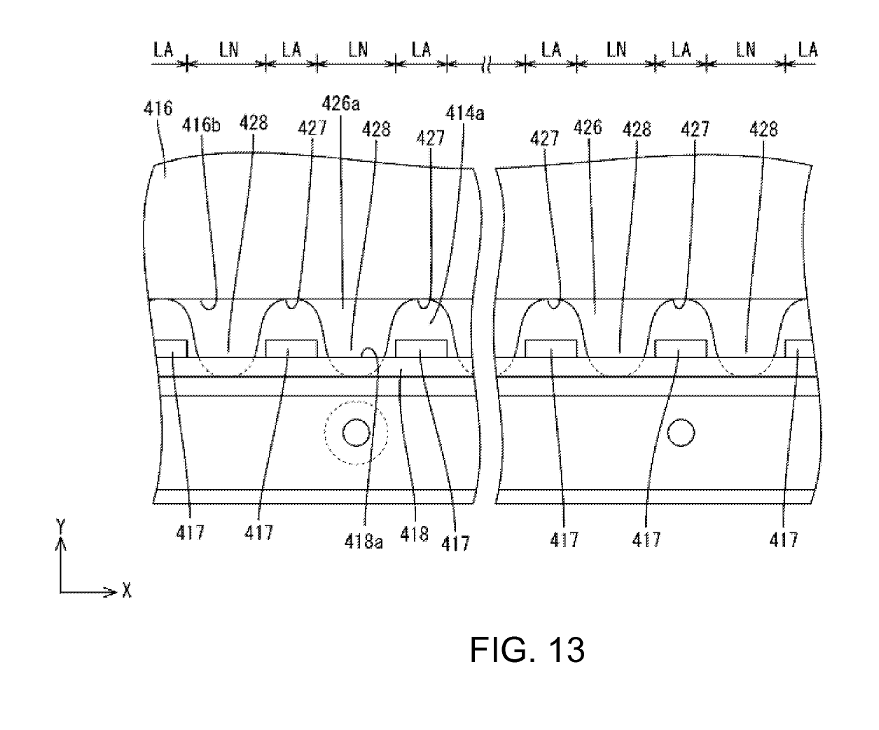

Embodiment 5 of the present invention will be described with reference to FIG. 13. In Embodiment 5, an area where openings 427 are formed is modified from the area in Embodiment 1. Descriptions of structures, operations, and effects similar to those of Embodiment 1 will be omitted.

As shown in FIG. 13, the openings 427 of the present embodiment are formed in the entire area of an extended reflective part 426 with respect to the Y axis direction (direction in which the extended reflective part 426 extends). More specifically, the openings 427 are formed not only in an extended edge portion of the extended reflective part 426, but also in an extended base section 426a with respect to the Y axis direction, and the furthest point on the edge thereof reaches a light-receiving surface 416b of a light guide plate 416. In this manner, in the areas LA where the light sources are arranged, which is the arrangement pattern of the LEDs 417, the extended reflective part 426 is not present in a region from a mounting surface 418a of an LED substrate 418 to the light-receiving surface 416b of the light guide plate 416, and portions of a bottom plate 414a of the chassis 414 are exposed in the entire area of such a region. This makes it possible to further reduce the amount of light reflected in the areas LA where the light sources are arranged. Protruding tabs 428 remaining in the extended reflective part 426 are configured so as to protrude from the light-receiving surface 416b toward the LEDs 417.

### Embodiment 6

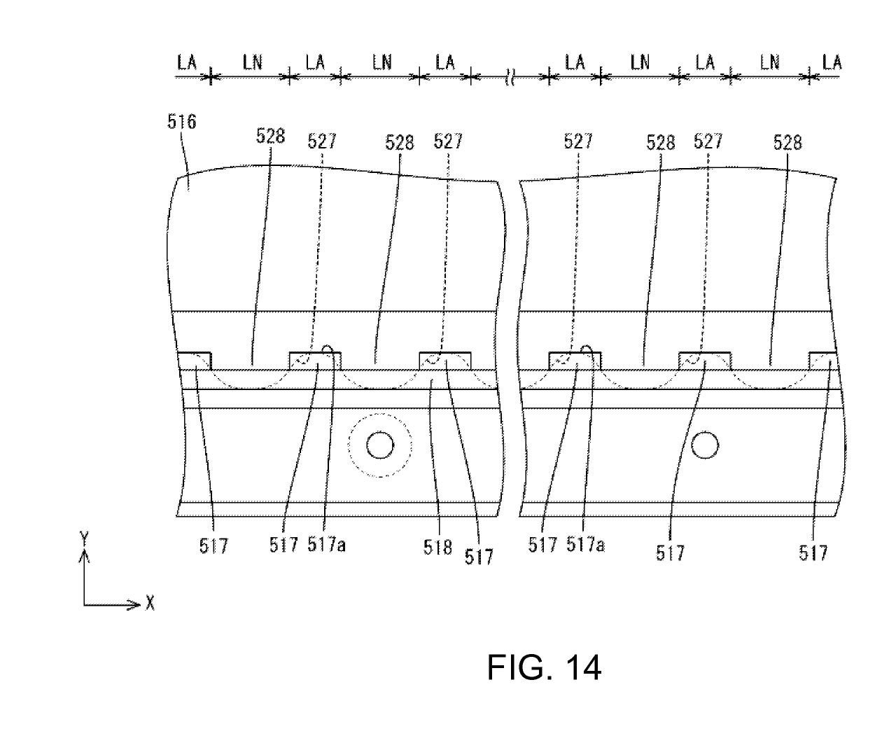

Embodiment 6 of the present invention will be described with reference to FIG. 14. In Embodiment 6, an area where openings 527 are formed is modified from the area in Embodiment 1. Descriptions of structures, operations, and effects similar to those of Embodiment 1 will be omitted.

As shown in FIG. 14, the openings 527 of the present embodiment are each formed in an area that overlaps a part of an LED 417 in a plan view. Specifically, the openings 527 are each formed such that, of the edge line thereof, a section that is located closer to a light guide plate 516 than an LED substrate 518 entirely overlaps an LED 517 in a plan view, and the furthest point on the edge coincide with a primary light-emitting surface 517a of the LED 517. Therefore, each of protruding tabs 528 remaining in an extended reflective part 526 is located so as to overlap a portion of the LED 517 in a plan view. With this configuration, it is possible to prevent the reflection light amount from being excessively reduced in the areas LA where the light sources are arranged.

### Other Embodiments

The present invention is not limited to the embodiments shown in the drawings and described above, and the following embodiments are also included in the technical scope of the present invention, for example.

(1) In the respective embodiments above, a sinusoidal wave shape, a square wave shape, a triangular wave shape, and a trapezoidal wave shape were shown as examples of the shape of the extended edge face of the extended reflective part, but the shape can be appropriately changed to other shapes such as a saw-tooth wave shape.

(2) In the respective embodiments above, an LED having a horizontally-long quadrangular shape in a plan view was shown as an example, but it is also possible to use an LED having an arc shape or semi-circular shape in a plan view, for example.

(3) In the configuration of (2) above, the plan view shape of the openings and protruding tabs of the extended reflective part may be changed to an arc shape, a semi-circular shape, and the like, corresponding to the outer shape of the LEDs.

(4) In addition to the shapes shown in the respective embodiments above, the plan view shape of the openings and protruding tabs of the extended reflective part may be appropriately changed, and the plan view shape of the openings and the protruding tabs may be a semi-oval shape, semi-ellipse shape, pentagon, or polygon having more than five sides, for example.

(5) In addition to the examples shown in the respective embodiments above, the forming area of the openings and protruding tabs of the extended reflective part with respect to the X axis direction (direction along which the LEDs are aligned), or the forming area thereof with respect to the Y axis direction (direction in which the extended reflective part extends) may be appropriately changed. The openings may be each formed in an area narrower than an LED with respect to the X axis direction, for example.

(6) In the respective embodiments above, the openings and the protruding tabs of the extended reflective part were each symmetric with respect to the X axis direction (direction along which the LEDs are arranged), but the present invention also includes a configuration in which the openings and protruding tabs are asymmetric with respect to the X axis direction.

(7) In the respective embodiments above, the openings and the protruding tabs of the extended reflective part are disposed so as to correspond to all of the areas where the light sources are arranged and all of the areas where the light sources are not arranged, respectively, but the present invention also includes a configuration in which one or both of the openings and the protruding tabs of the extended reflective part are disposed so as to correspond to only some of the areas where the light sources are arranged and some of the areas where the light sources are not arranged, respectively. Specifically, the openings and the protruding tabs may be arranged with uneven intervals with respect to the X axis direction (direction along which the LEDs are arranged).

(8) It is apparent that the configurations described in Embodiments 5 and 6 above, or in other words, the technical matter for the forming areas of the openings and protruding tabs, can be applied to the configurations described in Embodiments 2 to 4 above.

(9) In the respective embodiments above, the protruding members were formed integrally with the frame, but the present invention also includes a configuration in which the protruding members are separate parts from the frame, and are attached to the frame. In such a case, the protruding members may be made of a metal as in the frame, or may be made of a synthetic resin that is a different material from that of the frame.

(10) In the respective embodiments, the heat dissipating member was included in the LED unit, but the present invention also includes a configuration in which the heat dissipating member is omitted, and the LED substrate is directly attached to the chassis or the frame (protruding member). In such a case, the LED substrate can be configured to have the substantially L-shaped cross-section as in the heat dissipating member, and to be constituted of an LED mounting section on which the LEDs are mounted, and a heat dissipating section that makes surface-to-surface contact with the plate surface of the chassis.

(11) In the respective embodiments above, the heat dissipating section of the heat dissipating member protruded from the LED attachment section in a direction opposite to the light guide plate, but the present invention also includes a configuration in which the heat dissipating section protrudes from the LED attachment section toward the light guide plate.

(12) In the respective embodiments above, a pair of LED units (heat dissipating members, LED substrates) was disposed at the respective longer side edges of the light guide plate so as to face each other, but the present invention also includes a configuration in which the pair of LED units is disposed at the respective shorter side edges of the light guide plate so as to face each other, for example. In such a case, the extended respective parts may be formed at the respective shorter side edges of the reflective sheet.

(13) In addition to (12) above, the present invention includes a configuration in which two pairs of LED units (heat dissipating members, LED substrates), that is, total of four LED units, are disposed at the respective longer side edges and shorter side edges of the light guide plate so as to face each other, and a configuration in which one LED unit is disposed at one longer side edge or one shorter side edge of the light guide plate. The present invention also includes a configuration in which three LED units are disposed at three side edges of the light guide plate so as to face each other. When the arrangement and number of the LED units are changed as described above, the arrangement and number of the extended reflective parts of the reflective sheet may be changed according to the arrangement and number of the LEE units.

(14) In the respective embodiments above, one LED unit (heat dissipating member, LED substrate) was provided at one side of the light guide plate, but it is also possible to provide a plurality of (two or more) LED units at one side of the light guide plate. In such a case, it is preferable that the plurality of LED units be arranged along the side of the light guide plate.

(15) In the respective embodiments above, the frame and the chassis were both exterior members that constitute the exterior of the liquid crystal display device, but the present invention also includes a configuration in which a separately prepared exterior member is attached to the rear side of the chassis to cover the chassis such that the chassis is not exposed to the outside, for example. In addition, the present invention includes a configuration in which both the frame and chassis are covered by separately provided exterior members, so that neither frame nor the chassis is exposed to the outside.

(16) In the respective embodiments above, the chassis constituting an exterior member is made of metal, but the present invention also includes a configuration in which a chassis is made of a synthetic resin. It is preferable to employ this configuration in a mid- to small-sized model that does not require the liquid crystal display device to have very high mechanical strength.

(17) In the respective embodiments above, the chassis and the heat dissipating member were jointly fastened to the protruding member by the screw, but the present invention also includes a configuration in which a screw for affixing the chassis to the protruding member, and a screw for affixing the heat dissipating member to the protruding member are separately provided.

(18) The present invention also includes a configuration in which the screw for affixing the chassis to the protruding member is omitted from the configuration of (17) above, and a locking mechanism that engages the outer wall and the housing portion side wall of the chassis, for example, is provided.

(19) In the respective embodiments above, the power supply board was provided with the function of powering the LEDs, but the present invention also includes a configuration in which an LED driver board that powers the LEDs is separated from the power supply board.

(20) In the respective embodiments above, the main board was provided with a tuner part, but the present invention also includes a configuration in which a tuner board that has a tuner part is separated from the main board.

(21) In the respective embodiments above, the colored portions of the color filters provided in the liquid crystal panel included the three colors of R, G, and B, but it is possible to have the colored portions that include four or more colors.

(22) In the respective embodiments above, LEDs were used as the light source, but other types of light source such as an organic EL may also be used.

(23) In the respective embodiments above, TFTs were used as switching elements for the liquid crystal display device, but the present invention can also be applied to a liquid crystal display device using other types of switching elements than TFTs (such as thin-film diodes (TFD), for example), and in addition to a color liquid crystal display device, the present invention can be applied to a liquid crystal display device that conducts black and white display.

(24) In the respective embodiments above, a liquid crystal display device using a liquid crystal panel as a display panel was described as an example, but the present invention can be applied to a display device that uses another type of display panel.

(25) In the respective embodiments above, a television receiver that includes a tuner part was illustratively shown, but the present invention is also applicable to a display device without a tuner part.

### DESCRIPTION OF REFERENCE CHARACTERS

10 liquid crystal display device (display device)

11 liquid crystal panel (display panel)

12 backlight device (illumination device)

14, 114, 414 chassis

14a, 114a, 414a bottom plate

16, 126, 226, 416, 416, 516 light guide plate

16a light-emitting surface

16b, 216b, 316b, 416b light-receiving surface

17, 117, 217, 317, 417, 517 LED (light source)

18, 118, 418, 518 LED substrate (light source substrate)

20 reflective sheet (reflective member)

26, 126, 226, 326, 426, 526 extended reflective part

27, 127, 227, 327, 427, 527 opening

LA areas where light sources are arranged (arrangement pattern of light source)

LN areas where light sources not arranged (non-arrangement pattern of light source)

TV television receiver

1. An illumination device, comprising:
a plurality of light sources arranged at intervals;
a light guide plate having a light-receiving surface facing the light sources to receive light from the light sources and a light-emitting surface through which light that entered the light guide plate is emitted;
a reflective member disposed to cover a surface of the light guide plate opposite to the light-emitting surface, the reflective member reflecting light toward the light-emitting surface; and
an extended reflective part laterally extending from an edge of the reflective member beyond the light-receiving surface toward the light sources, the extended reflective part having a shape consistent with an arrangement pattern of the light sources such that the extended reflective part is absent below the light sources and is present between the light sources.

2. The illumination device according to claim 1, further comprising:
a light source substrate on which the plurality of light sources is mounted; and
a chassis having a bottom plate that is disposed on the reflective member on a side opposite to the light guide plate, the chassis housing the light source substrate, the light guide plate, and the reflective member,
wherein the extended reflective part extends such that the extended reflective part is interposed between the light source substrate and the bottom plate of the chassis.

3. The illumination device according to claim 1,
wherein the extended reflective part is formed such that an extension edge face thereof has recesses and protrusions that repeat periodically in a direction along which the plurality of light sources are aligned.

4. The illumination device according to claim 3,
wherein the recesses are formed in an entire area that corresponds in position to the light sources in a plan view.

5. The illumination device according to claim 3,
wherein the recesses each have a symmetric shape with respect to said direction along which the light sources are aligned, and
wherein the light sources are each positioned so as to share the same center as a corresponding one of the recesses with respect to said direction along which the light sources are aligned in a plan view.

6. The illumination device according to claim 3,
wherein the recesses have a shape consistent with an outer shape of the light sources.

7. The illumination device according to claim 3,
wherein the extended reflective part is formed such that an area of each of the recesses becomes smaller in a direction from the light sources toward the light guide plate, such that an area of the extended reflective part becomes larger in the direction from the light sources toward the light guide plate.

8. The illumination device according to claim 7,
wherein the extended reflective part is formed such that an extension end face thereof has a sinusoidal wave shape.

9. The illumination device according to claim 7,
wherein the recesses each have a tapered shape such that an area thereof becomes smaller in the direction from the light sources toward the light guide plate.

10. The illumination device according to claim 1,
wherein the light sources are light-emitting diodes.

11. A display device, comprising:
the illumination device according to claim 1; and
a display panel that conducts display using light from the illumination device.

12. The display device according to claim 11,
wherein the display panel is a liquid crystal panel constituted of a pair of substrates with liquid crystal sealed therebetween.

13. A television receiver, comprising the display device according to claim 11.
